(19) United States
(12) Patent Application Publication
(10) Pub. No.: US 2023/0024872 A1
(43) Pub. Date: Jan. 26, 2023

(54) Condensation Countermeasures for Airborne Particle Detectors

(71) Applicant: Scanit Technologies, Inc., Fremont, CA (US)

(72) Inventors: Pedro Manautou, Milpitas, CA (US); Joel Kent, Fremont, CA (US); Keith Nordman, Palo Alto, CA (US)

(21) Appl. No.: 17/848,017

(22) Filed: Jun. 23, 2022

Related U.S. Application Data
(60) Provisional application No. 63/222,585, filed on Jul. 16, 2021.

(51) Int. Cl. G01N 1/44; G01N 15/06; G01N 15/14; H04N 5/235; G06V 20/69; G06V 10/60

(52) U.S. Cl. CPC G01N 1/44; G01N 15/06; G01N 15/1434; H04N 5/2354; G06V 20/693; G06V 20/698; G06V 20/695; G06V 10/60; G01N 2015/0693; G01N 2015/0046

(57) ABSTRACT

Condensation associated with the collection and identification of airborne particles is detected. Upon the detection, one or more condensation countermeasures are triggered to address the condensation.

### CROSS-REFERENCE TO RELATED APPLICATIONS

This application claims priority to U.S. provisional patent application 63/222,585, filed Jul. 16, 2021, and is incorporated by reference along with other cited references in this application.

### BACKGROUND

The present invention relates to the identification of airborne particles and, more specifically, to systems and techniques to address condensation.

There remains a need in agriculture to physically detect airborne pathogens before infestation enabling preventative action. Being able to capture, inspect, classify, and alert growers of the presence of harmful airborne pathogen spores allows growers to take preventative actions, optimize pest management practices, and minimize yield losses.

Monitoring of pathogen spores is also of interest during produce transportation and storage, such as in large indoor storage facilities where apples may be kept for many months.

There are many other applications for airborne particle monitors. For human health, it is of interest to monitor airborne allergens such as pollen and mold spores. Detection of airborne pathogens that effect the health of pets, livestock and other animals may also be of interest. Further applications for monitoring of airborne particles, not necessarily pathogens, may develop in the future.

One challenge, however, in identifying airborne particles is the presence of condensation. The condensation can make it difficult to identify a particle as being a pathogen spore. Condensation may also lead to undesirable corrosion.

### BRIEF SUMMARY OF THE INVENTION

In an embodiment, condensation associated with the collection and identification of airborne particles is detected. Upon the detection, one or more condensation countermeasures are triggered to address the condensation.

### BRIEF DESCRIPTION OF THE FIGURES

FIG. 1 shows a block diagram of an airborne particle detector according to one or more embodiments.

FIG. 2 shows a graph of saturation vapor pressure shown as a function of temperature: e° (T) curve.

FIG. 3A shows an image with particles of interest only.

FIG. 3B shows an image with both particles of interest and background water droplets.

FIG. 4 shows a sketch representing a dry spore.

FIG. 5 shows a sketch representing a spore on which condensation has created a capillary layer.

FIG. 6 shows a sketch representing a moist spore.

FIG. 7 shows an exterior front view of an airborne particle detector according to one or more embodiments.

FIG. 8 shows an isometric view of a particle media cartridge that may be used with the particle detector shown in FIG. 7 according to one or more embodiments.

FIG. 9 shows an inside side view of the cartridge shown in FIG. 8 according to one or more embodiments.

FIG. 10 shows an inside side view of the particle detector shown in FIG. 7 according to one or more embodiments.

FIG. 11 shows an inside side view of a portion of a particle detector having a heater in a removable cartridge of the particle detector according to one or more embodiments.

FIG. 12 shows an inside side view of a portion of a particle detector having a heater in an optical platform of the particle detector according to one or more embodiments.

FIG. 13 shows a lengthwise vertical cross section of an axial resistor according to one or more embodiments.

FIG. 14 shows an end view of the axial resistor shown in FIG. 13.

FIG. 15 shows a lengthwise vertical cross section of the axial resistor in a sleeve according to one or more embodiments.

FIG. 16 shows an end view of the axial resistor shown in FIG. 15.

FIG. 17 shows a lengthwise vertical cross section of the axial resistor in the sleeve with ends filled according to one or more embodiments.

FIG. 18 shows an end view of the axial resistor shown in FIG. 17.

FIG. 19 shows a lengthwise side view of the axial resistor shown in FIG. 17 according to one or more embodiments.

FIG. 20 shows a front view of an optical platform of a particle detector having a heater according to one or more embodiments.

FIG. 21 shows a bottom view of the optical platform shown in FIG. 20 according to one or more embodiments.

FIG. 22 shows an isometric view from below of the optical platform with local heater according to one or more embodiments.

FIG. 23 shows a spreadsheet for heating power calculation according to one or more embodiments.

FIG. 24 shows an example of an equivalent circuit according to one or more embodiments.

FIG. 25 shows an isometric view of a housing (door) portion including intake slot and concave indentation according to one or more embodiments.

FIG. 26 shows a horizontal cross section of housing and cartridge portions near the intake slot and having a concave indentation according to one or more embodiments.

FIG. 27 shows a horizontal cross section of housing and cartridge portions near the intake slot and not having the concave indentation according to one or more embodiments.

FIG. 28 shows an inside side view of a particle detector having a desiccator according to one or more embodiments.

FIG. 29 shows an inside side view of a particle detector having a desiccator and heater according to one or more embodiments.

FIG. 30 shows a side view of a water drop on a collection surface according to one or more embodiments.

FIG. 31 shows a top view of the water drop on the collection surface according to one or more embodiments.

FIG. 32 shows a block diagram of components of a particle identification subsystem according to one or more embodiments.

FIG. 33 shows a block diagram of a particle reference library according to one or more embodiments.

FIG. 34 shows a block diagram of another particle reference library according to one or more embodiments.

FIG. 35 shows a block diagram of another particle reference library according to one or more embodiments.

FIG. 36 shows an overall flow for activating condensation countermeasures according to one or more embodiments.

FIG. 37 shows an example flow of a condensation countermeasure according to one or more embodiments.

FIG. 38 shows a flow for a particle reference library according to one or more embodiments.

FIG. 39 shows a flow for detecting water droplets in an image according to one or more embodiments.

FIG. 40 shows another flow for a particle reference library according to one or more embodiments.

FIG. 41 shows an inside side view of a particle detector according to one or more embodiments.

FIG. 42 shows a side view of a particle detector without a lens.

FIG. 43 shows a side view of a particle detector without a lens and having a heater according to one or more embodiments.

FIG. 44 shows a side view of another particle detector without a lens and having a heater according to one or more embodiments.

FIG. 45 shows an isometric side view of a particle detector that does not generate 2-D images.

FIG. 46 shows an isometric side view of a particle detector that does not generate 2-D images and has a heater according to one or more embodiments.

FIG. 47 shows an isometric side view of another particle detector that does not generate 2-D images and has a heater according to one or more embodiments.

FIG. 48 shows a block diagram of a client-server system and network in which an embodiment of the system may be implemented.

FIG. 49 shows a system block diagram of a client or server computer system shown in FIG. 48.

### DETAILED DESCRIPTION

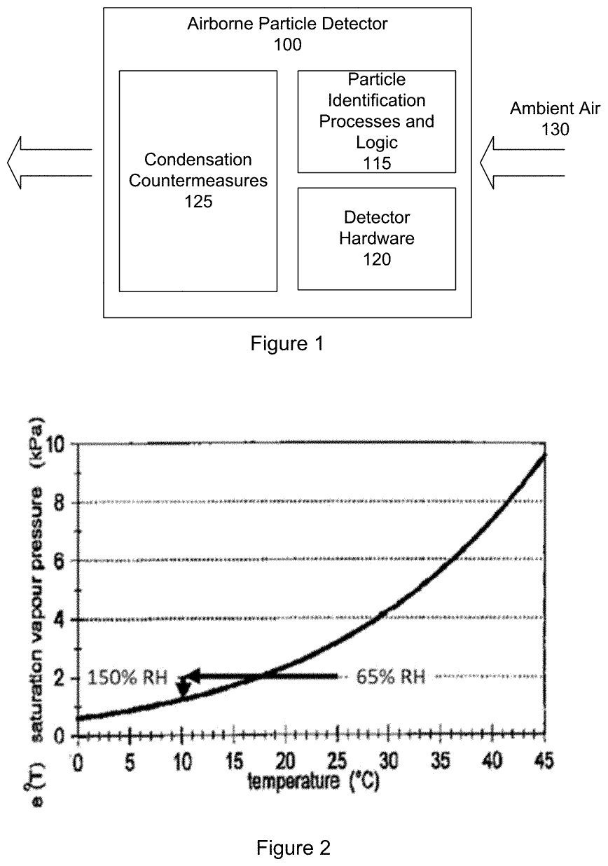

FIG. 1 shows a simplified block diagram of an airborne particle detector 100 according to one or more embodiments. The detector may be referred to as a monitor or particle monitoring device. The detector includes particle identification processes and logic 115, detector hardware 120, and condensation countermeasures 125.

These components work together to draw in or sample ambient air 130, collect particles that may be present in the air, direct light or radiation into the collected particles, capture one or more images of the collected particles, and analyze the images in order to identify the particle. In an embodiment, the identification and classification of particles is based on image recognition and spectral analysis techniques. The particles are optically probed by being subjected to certain lighting or radiation conditions. Images are then taken of the particles. Analysis of the images includes examining how different wavelengths or colors of light (which may include ultraviolet light) are absorbed, reflected, or scattered according to the images. A detailed discussion of collection and analysis techniques is provided in U.S. patent application Ser. No. 15/178,170, filed Jun. 9, 2016, now U.S. Pat. No. 9,933,351, issued Apr. 3, 2018; U.S. patent application Ser. No. 15/667,829, filed Aug. 3, 2017, now U.S. Pat. No. 10,458,990, issued Oct. 29, 2019; and U.S. patent application Ser. No. 15/895,431, filed Feb. 13, 2018, now U.S. Pat. No. 10,684,209, issued Jun. 16, 2020. These patents are assigned to the same assignee as this patent application and are incorporated by reference along with all other references cited.

The condensation countermeasures include processes, hardware components, or both to address condensation that may be present in the ambient air to facilitate an accurate identification of the airborne particles.

Condensation Conditions

FIG. 2 shows a graph of saturation vapor pressure as a function of temperature: e° (T) curve. The figure is copied from the website http://www.fao.org/3/X0490E/x0490e07.htm. Two arrows and relative humidity (RH) values have been added to the plot. Water condensation occurs when air becomes overly saturated with water vapor, that is, when the relative humidity (RH) exceeds 100 percent (%). The curve in FIG. 2 illustrates how the saturation water vapor content of air increases with temperature. Per this curve, if the temperature increases by 10° C., the amount of water air can hold increases by roughly a factor of two.

As a specific concrete example, imagine that during the day the temperature reaches a high of 25° C. and a relative humidity (RH) of 65%, and then late at night the temperature drops to 10° C. If the absolute water content of the air were to remain the same (at a vapor pressure of 2 kPa), the relative humidity at 10° C. would increase to 150%. Such super-saturation is not stable and results in water condensation.

We may experience such water condensation as dew, such as water condensing on blades of grass. We may also experience such water condensation as fog, where water droplets form in the air. These are examples where condensation occurs in the ambient environment due to a drop in temperature.

Condensation may also occur when ambient air is saturated or close to saturation, and the airborne particle device is colder than ambient air. Sampled ambient air is cooled when entering the device, possibly leading to condensation. This scenario might occur in a greenhouse when the morning sun warms up and humidifies the greenhouse air faster than it heats up the particle monitoring device.

Condensation conditions may also be encountered in airborne particle detector applications outside of agriculture. For example, consider an airborne particle monitor being used to monitor mold spores during mold remediation after repair of a leaking water pipe. Wet items from the leak may saturate the air leading to condensation when the temperature drops at night.

Problems Caused by Condensation

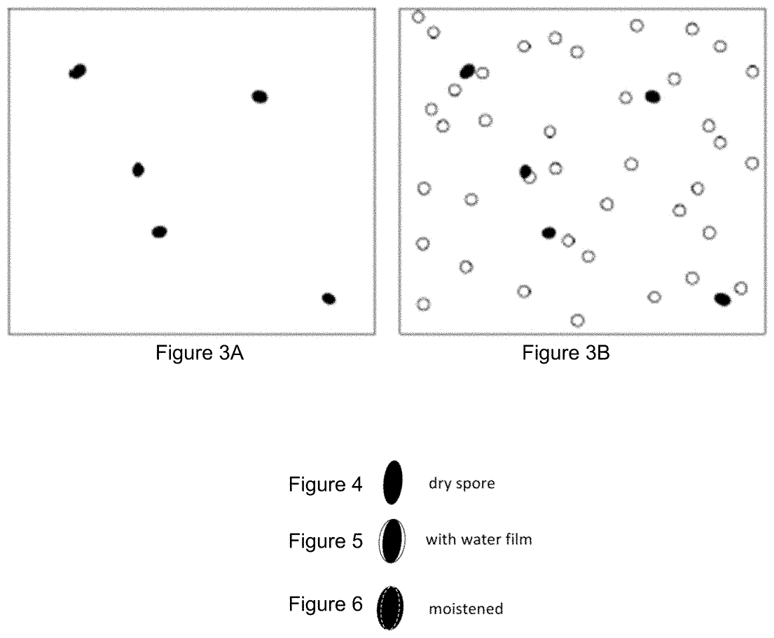

Water condensation can negatively affect the performance of an airborne particle detector in two ways. The creation of water droplets may be a problem via increasing the number background particles, thus complicating recognition and analysis of the particles of interest. This is conceptually illustrated in FIGS. 3A and 3B. FIG. 3A shows an image with particles of interest only (solid black ovals). FIG. 3B shows an image with both particles of interest (solid black ovals) and background water droplets (open circles). The image shown in FIG. 3B with background water droplets is more difficult to analyze.

Water that condenses on particles of interest may be another problem. The optical signatures of particles of interest may well change due to water condensation. If water condensing on a particle of interest is absorbed by the particle, the moistened particle may well swell and change shape and other optical characteristics. (An analogy here is that a dried prune looks different after being stewed in water.) If instead, or in addition, condensed water forms a water film on a particle of interest, the water film may also modify the particle's optical signatures. Such a water film is also referred to as a capillary layer.

These issues with water condensation on particles of interest are illustrated in the conceptual sketches shown in FIGS. 4-6. FIG. 4 shows a representation of a dry spore before water condensation. FIG. 5 shows a representation of a spore on which condensation has created capillary layer (a film of water). FIG. 6 shows a representation of a moistened spore that has changed shape due to absorption of condensed water. Condensed water on a spore, or other particle of interest, changes its optical signature. Capillary layers on pollen grains are likely to remain as capillary layers. In contrast, condensed water on fungal spores is more likely to be absorbed.

Independent of its effects on spore image quality, in some applications condensation may also be undesirable for an entirely different reason, namely, corrosion. This may be of particular concern in applications, such as apple cold storage, which use air enriched in carbon dioxide (CO₂). When carbon dioxide diffuses into water drops, carbonic acid (H₂CO₃) is formed, potentially leading to undesired corrosion of susceptible components and materials. For example, electronics and copper wiring may be susceptible to acidic water droplets. Such susceptible components and materials may be coated or embedded with protective materials such as silicone potting compound. Alternatively, or in addition, condensation of acidic water droplets can be avoided using condensation countermeasure methods described further below in this document.

Droplets From Other Sources

There can be droplets from other sources. As noted above, one possible problem associated with condensation is an increased number of background particles. Some countermeasures for an increased number of background particles may be effective for other causes of increased numbers of background particles, such as agricultural spraying.

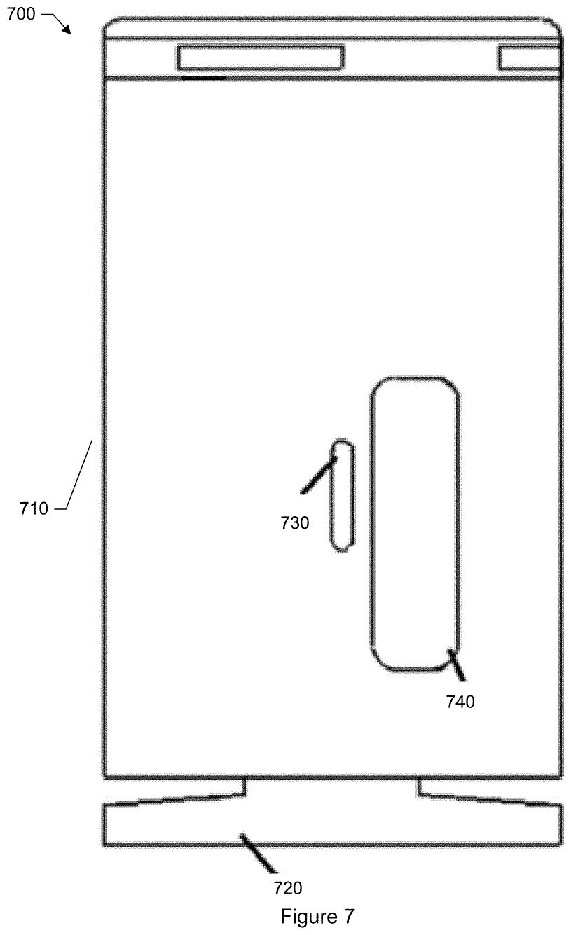

FIG. 7 shows a front view of a particle detector 700. This particle detector includes one or more countermeasures to address condensation. Condensation countermeasures may include hardware, software processes, or both. In an embodiment, systems and techniques to reduce or eliminate condensation includes heating.

The detector includes a housing 710 that contains most of the device components. The housing is rotatably connected to a base 720. The housing includes an opening that may be referred to as an air-intake slot 730 and a cartridge door 740 next to the air-intake slot. The air-intake slot forms a funnel-like shape as it penetrates the thickness of the housing. The cartridge door opens to allow for the insertion and removal of a media cartridge within which particles in the ambient air are collected.

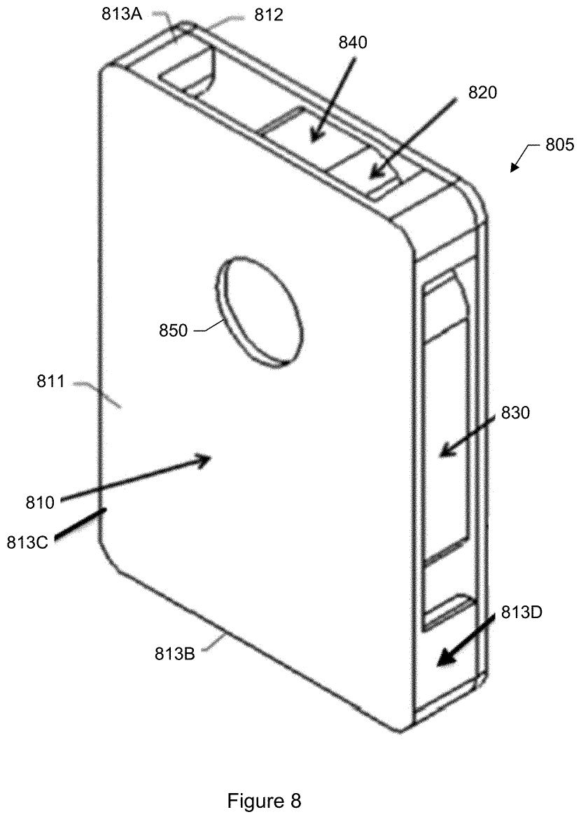

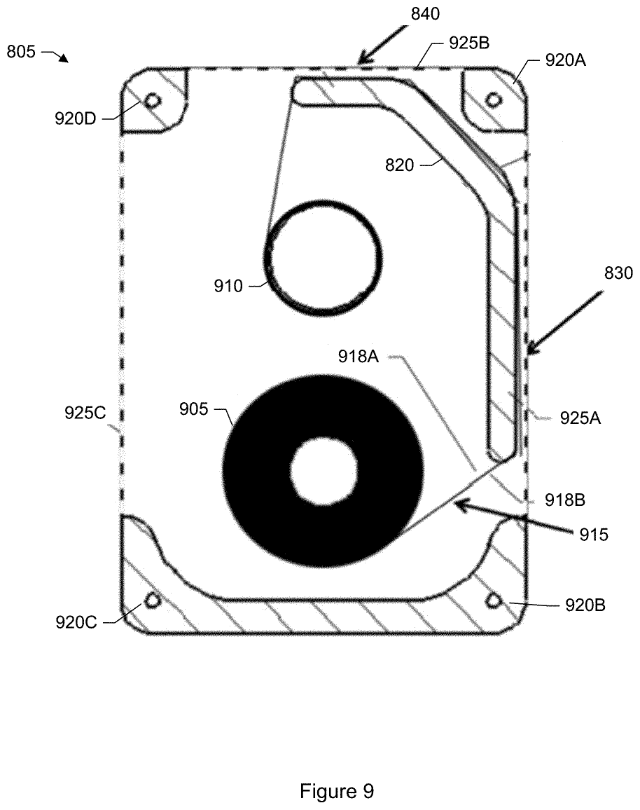

FIGS. 8-9 show views of a media cartridge 805 that may be loaded into the particle detector via the cartridge door. The cartridge may be referred to as a cassette. The cartridge includes a cartridge body 810, a front panel 811, a back panel 812, opposite the front panel. Side panels including a top side panel 813A, a bottom side panel 813B, a left side panel 813C, and a right side panel 813D extend between the front and back panels. The cartridge body holds or contains an adhesive coated tape media for capturing particles, and a tape guide structure 820 to guide the tape media. The tape guide structure includes a portion 830 that may be referred to as a particle collection zone, and a portion 840 that may be referred to as a particle inspection zone. A gear-shaft hole 850 allows particles collected onto the tape media at the particle collection zone to be advanced to the particle inspection zone.

FIG. 9 shows an inside view of the media cartridge. The media cartridge includes a supply reel 905, uptake reel 910, and tape guide structure 820 with particle collection zone 830 and particle inspection zone 840. The supply reel holds tape media 915 having an inside surface 918A and outside surface 918B, opposite the inside surface, that is coated with an adhesive. The tape extends from the supply reel to the tape guide structure, across the particle collection zone, to the particle inspection zone, and terminates at the uptake reel. Mounting points 920A-D allow for the fastening of a cover panel. Openings 925A-C at respective sides of the cartridge are indicated by broken line segments.

Specifically, opening 925A corresponds to the particle collection zone. When the cartridge is loaded into the detector, the cartridge is positioned so that the particle collection zone is next to the air-intake slot and thus facing a flow of ambient air being drawn into the detector. Airborne particles present in the air are trapped by the adhesive coated tape. The air exhausts out from the cartridge through opening 925C. The portion of the tape at the particle collection zone and having the trapped particles can be advanced to the particle inspection zone. There is an illumination and optical assembly above the particle inspection zone. The illumination assembly may include multiple light sources such as multiple light emitting diodes (LEDs). The light sources may be arranged at different positions about the inspection zone. A light source may emit light that is different from or the same as light emitted by another light source. The optical assembly may include a camera sensor and lens. Opening 925B at the particle inspection zone allows light from the illumination assembly to be directed at the trapped particles and images to be captured by the optical assembly.

Hardware Components To Reduce Or Eliminate Condensation—Heating

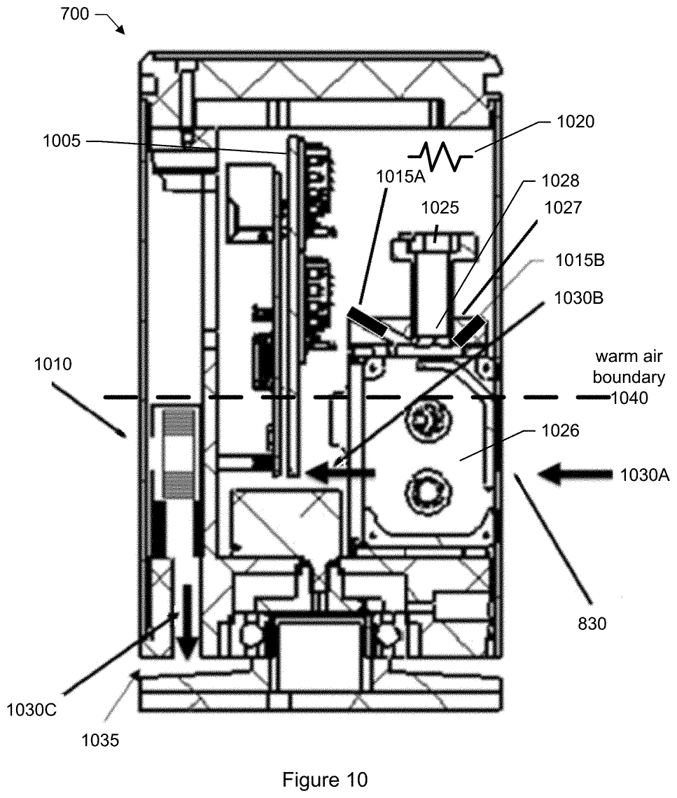

FIG. 10 shows an inside side view of the detector with cartridge 805 having been loaded. There is a motherboard 1005 providing connectivity to hardware components of the detector including processor, memory, storage, power supply (e.g., battery), a blower 1010, light or radiation sources (e.g., light emitting diodes (LEDs) 1015A,B), heater 1020, cartridge motor, and camera sensor 1025. Other hardware components that may be included and connected to the processor include climate sensors such as humidity sensors, temperature sensors, and so forth. An optical platform 1027 is located above a cartridge well 1026 or holder that holds the cartridge. In an embodiment, the optical platform provides a mounting structure for the light sources, optical column including the camera sensor and a lens 1028, and the heater. In a specific embodiment, the light sources include three white LEDs and a single ultraviolet (UV) LED.

The blower creates a vacuum to draw ambient air through the detector. Arrows 1030A-C indicate a direction of air flow through the detector. Air passes through the air-intake slot, to the particle collection zone, through the cartridge, and out the detector through an exhaust 1035.

In an embodiment, to reduce, avoid, or eliminate condensation, the relative humidity (RH) is brought below 100%. This can be done either by increasing the temperature, e.g., by heating, or by removing water vapor from the air, e.g., by desiccation, or both. Let us first consider heating.

The heater, indicated by a resistor symbol, is included to raise the temperature inside the device relative to the ambient temperature outside the device. If the inside temperature is sufficiently elevated, the internal relative humidity drops below 100% even when external relative humidity is 100% or larger. This halts condensation and enables evaporation of existing droplets.

In FIG. 10 one heater 1020 is shown in the upper portion of the device. In other embodiments, additional heaters (not shown) may be placed at additional locations within the device to better provide heating throughout the device volume. This may be of interest if the goal is not only to avoid negative effects of condensation droplets on image quality, but also to avoid corrosion from (possibly acidic) water droplets. For example, it may be desirable to avoid condensation on motherboard 1005.

In some applications, electrical power for heaters may be provided. For example, in an indoor apple storage facility, power might be provided by electrical outlets. In other applications, carefully managing power consumption is more critical. For example, excessive power consumption by heaters is to be avoided for a device installation located in a corn field and having a self-contained solar panel and battery power supply.

In an embodiment, heating of a lower portion of the device is made difficult by the constant flow of ambient air (e.g., 1030A) through the air intake slot, past the particle collection zone, through the cartridge as indicated by internal air arrow 1030B, and on through the blower to the exhaust. It may be sufficient that the desired elevated temperature is provided in the vicinity of the particle inspection zone. This sufficient condition may be met, for example, if energy delivered to the heater is sufficient to warm the detector above a “warm air boundary” as indicated by a broken line 1040, even if below the boundary the air is not warmed enough to avoid condensation.

For applications with concerns regarding corrosion due to condensation of (acidic) water droplets, it is preferable to place corrosion sensitive components above the warm air boundary 1040. For example, as shown in FIG. 10, it may be desirable to place the motherboard 1005 partially to totally above the warm air boundary 1040.

Addition of thermal insulation, such as a layer of foam, foil, or both to the inside of at least a portion of housing 710 may reduce the amount of energy that needs to be provided to heater 1020 to maintain a desired temperature differential. In some cases, heat generated by motherboard 1005 may be sufficient, eliminating the need for a separate heating element.

Additional air baffles may be added to further segregate the unheated air below the boundary from the heated volume above the boundary.

When ambient temperature and humidity is predictable and stable, such as inside an apple storage facility, the thermal design may be fine-tuned to efficiently suppress undesired condensation.

In particular, if corrosion due to water droplets is of little concern and the goal is to protect image quality, the energy demands of the heater may be reduced if it is strategically located where it is most needed.

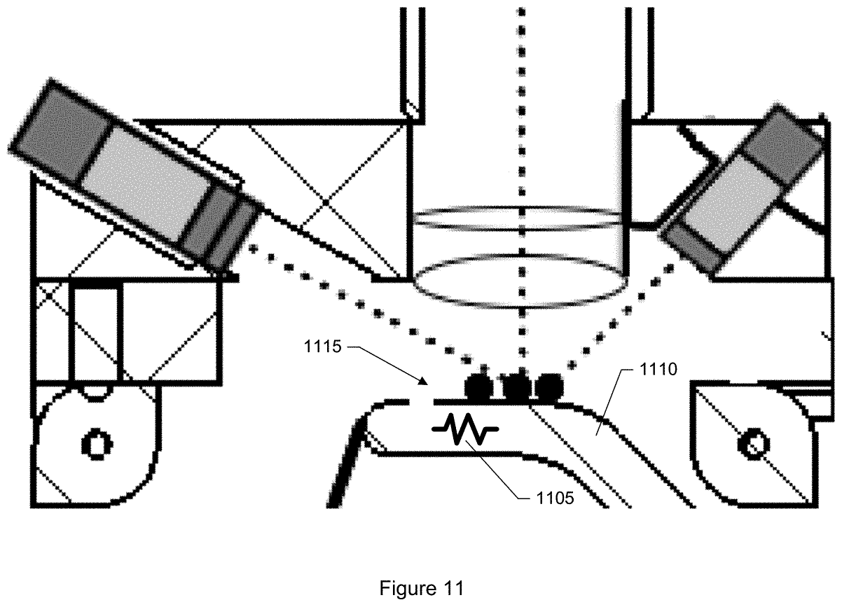

FIG. 11 shows an example of a local heater 1105 embedded inside a tape guide structure 1110 behind or below a particle inspection zone 1115 according to one or more embodiments. Even with a very modest energy budget, such a strategically placed heating element may evaporate any water droplets, and dry out any particles of interest, in the particle inspection zone.

The approach shown in FIG. 11 has the disadvantage of placing the local heater within the removable and replaceable media cartridge, thus increasing the cost of this consumable item. This approach also requires electrical connection between the monitor and media cartridge. In an embodiment, there is a resistor heater in a cassette or cartridge. The resistor heater may be a metal pin. In another embodiment, tape media itself may have some conductivity and be a heater with metal pins as contacts. In most applications, it is much preferable to make the local heater a permanent part of the monitor. Depending on other factors and applications, it may be desirable to include a heater within the cartridge.

For example, in another embodiment, the local heater may be embedded in the optical platform. The local heater may be a resistor to which a voltage “V” is applied and a current “I” is passed. The electrical power, P=I²R=V²/R, consumed by the resistor is converted to heat. The resistor may be, for example, a standard axial resistor, a surface mount resistor, or a length of nichrome wire.

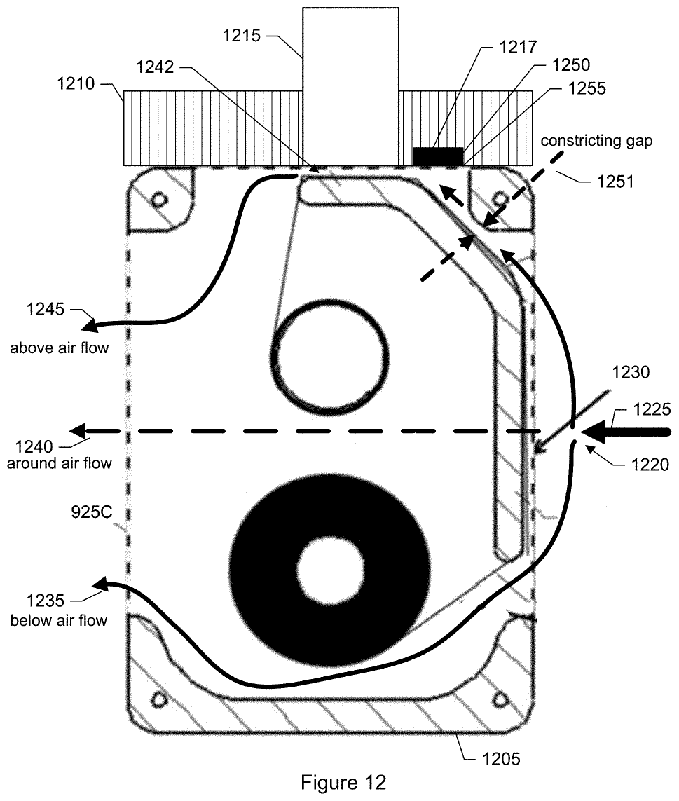

A local heater may be placed to directly heat the particle inspection zone. In some applications this is difficult to do without mechanical interference with other components such as the lens. The inventors have discovered that it may be advantageous to heat the particle inspection zone indirectly. The local heater may be placed to heat air that then flows through the particle inspection zone. That is, from the perspective of air flow, the local heater may be placed upstream of the particle inspection zone. An example design is illustrated in FIG. 12.

FIG. 12 shows a vertical cross section of a media cartridge 1205 and above it an optical platform 1210 with an optical column 1215 (other components are not shown for clarity). The optical platform includes a local heater 1217. Arrows 1220 represent air flow. After passing through the air intake slot of the monitor housing (not shown), input air flow 1225 impacts a particle collection zone 1230. All input air flow eventually exits through a blower (not shown) and out of the monitor housing. As illustrated by the arrows in FIG. 12, there are multiple air flow paths from the particle collection zone to the blower. Some air goes through the cartridge below the supply reel and is labeled “below air flow” 1235 in the figure. Some air goes around the cartridge as indicated by the dotted arrow labeled “around air flow” 1240. In the perspective of the figure, the around air flow may go both in front of, and behind of the cartridge.

Of particular interest for local heating of a particle inspection zone 1242 is air flow 1245 that follows the media tape path from the particle collection zone to the particle inspection zone, and then continues above and to the left of the take-up reel and exits the cartridge. See the air flow path indicated by three arrows 1235, 1240, and 1245, that last one of which is labeled “above air flow”.

As illustrated in FIG. 12, the local heater may be placed in the optical platform adjacent to the above air flow path so as to heat air upstream of the particle inspection zone. This heated air may dry out the particles of interest before they reach the particle inspection zone as well as carry drying heat to the particle inspection zone.

As shown in the example of FIG. 12, the heater is positioned above a beginning portion 1250 of the particle inspection zone with respect to a direction of the above air flow. This beginning portion may be referred to as a drying zone. The heater is directly above broken lines 1255 of the cartridge and which indicate opening 925B (FIG. 9). In other words, the heater is upstream of the particle inspection zone with respect to the flow path of air and faces opening 925B. The positioning of the heater promotes the transfer of heat in a downwards direction towards the particles collected onto the tape media of the collection cartridge and exposed through opening 925B. The heat applied by the heater facilitates the reduction, removal, or evaporation of condensation that may have formed on the tape media or saturated the collected particles before the collected particles are imaged by the camera sensor. In an embodiment, the heater, while shown in FIG. 12 as being next to the optical column, does not contact or touch lenses of the optical column.

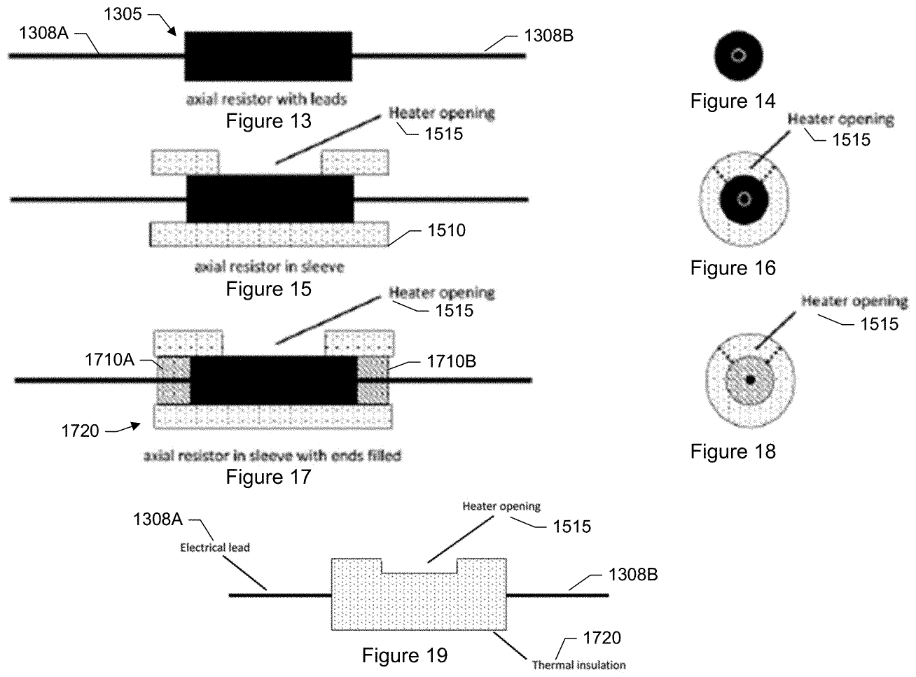

FIGS. 13-18 show views for a construction of a local heater according to one or more embodiments. FIG. 13 shows a side view or lengthwise vertical cross section of a standard axial resistor 1305 with leads 1308A,B. FIG. 14 shows an end view of the axial resistor shown in FIG. 13.

It is desirable that heat generated at such a resistor be directed toward the above air flow and away from the optical platform material. As illustrated in FIG. 15, in an embodiment, this is accomplished by placing the resistor in a sleeve 1510 with an opening 1515. FIG. 16 shows an end view of the axial resistor with sleeve shown in FIG. 15. The sleeve may made of plastic, preferably foamed, to provide a level of thermal insulation.

FIG. 17 shows a side view of ends 1710A,B of the sleeve having been filled. FIG. 18 shows an end view of the sleeve with filled ends shown in FIG. 17. For further thermal insulation and for mechanical robustness, the ends of the sleeve may be filled with an adhesive, preferably a foamed adhesive. The sleeve with filled ends thus forms a thermal insulation 1720.

The sketches shown in FIGS. 13,15, and 17 are cross sections. FIG. 19 shows the same assembly as shown in FIG. 17, but from a lengthwise side view rather than cross section. The intention is that most of the electrical power delivered through the electrical leads exits the heater opening as heat in air rather than via heat conduction through the sleeve (or thermal insulation 1720) to the solid material of the optical platform.

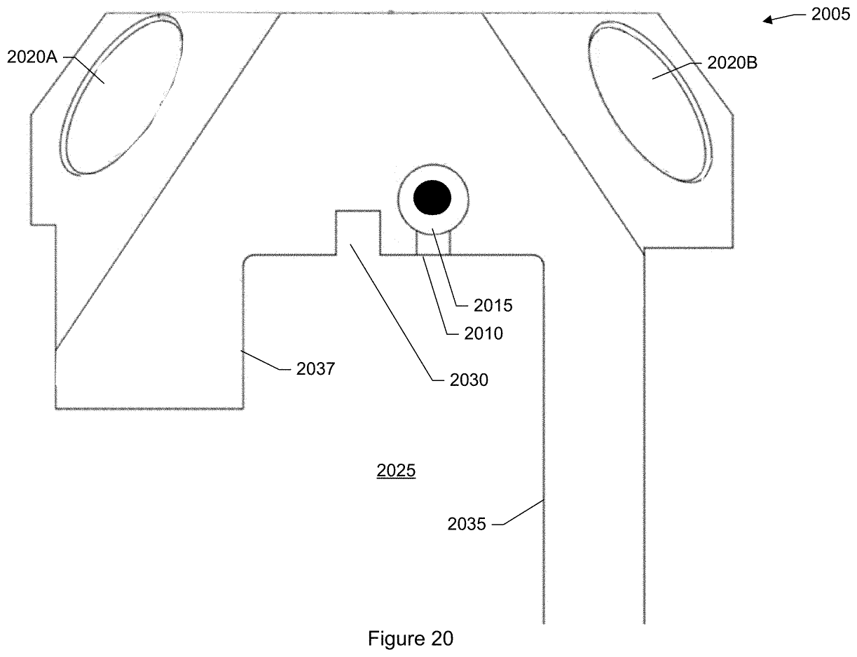

In an embodiment, the optical platform is provided with an appropriately shaped and placed groove to receive such a sleeved-resistor local heater. FIGS. 20-22 show various views of an optical platform having a local heater and local heater grove. The three drawings in FIGS. 20-22 show the same optical platform from three different perspectives, respectively.

More particularly, FIG. 20 shows a front view of an optical platform 2005. The optical platform includes a local heater groove 2010 into which a local heater 2015 is secured, a first hole 2020A to mount a first light source, a second hole 2020B to mount a second light source, cartridge holder 2025, and a notch 2030 for a cartridge key to ensure that the cartridge is inserted correctly into the cartridge holder. A side 2035 of the optical platform connects to a bottom of the cartridge holder. The heater is positioned at a top of the cartridge holder and next to the notch. The heater is closer to side 2035 than a side opposite side 2037.

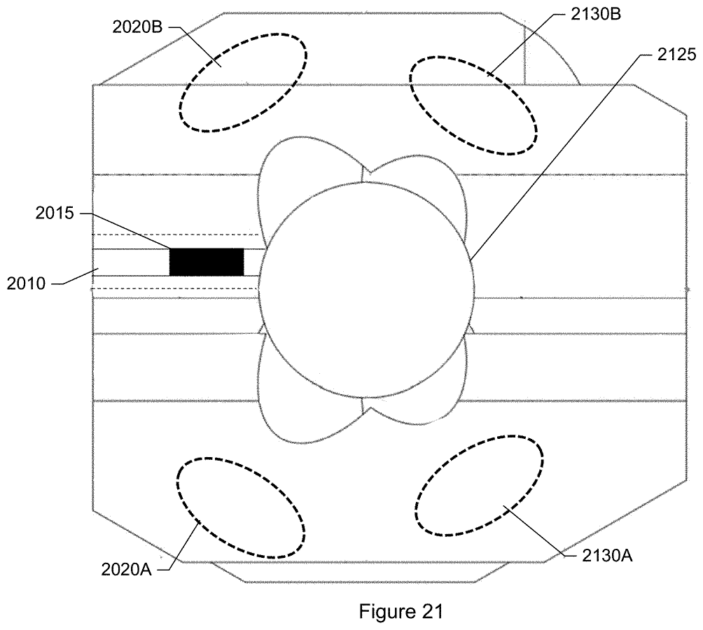

FIG. 21 shows a bottom view of the optical platform shown in FIG. 20. The view is from a bottom of the optical platform to a top of the optical platform. As shown in FIG. 21, there is the local heater groove into which the local heater is secured, and a hole 2125 for an optical column. Oval shaped broken lines indicate first hole 2020A to mount the first light source, second hole 2020B to mount the second light source, a third hole 2130A to mount a third light source, and a fourth hole 2130B to mount a fourth light source. In an embodiment, the light sources are LEDs. Thus, the hole openings may be referred to as LED hole openings. The hole openings are shown in broken lines to indicate that they are not visible from below.

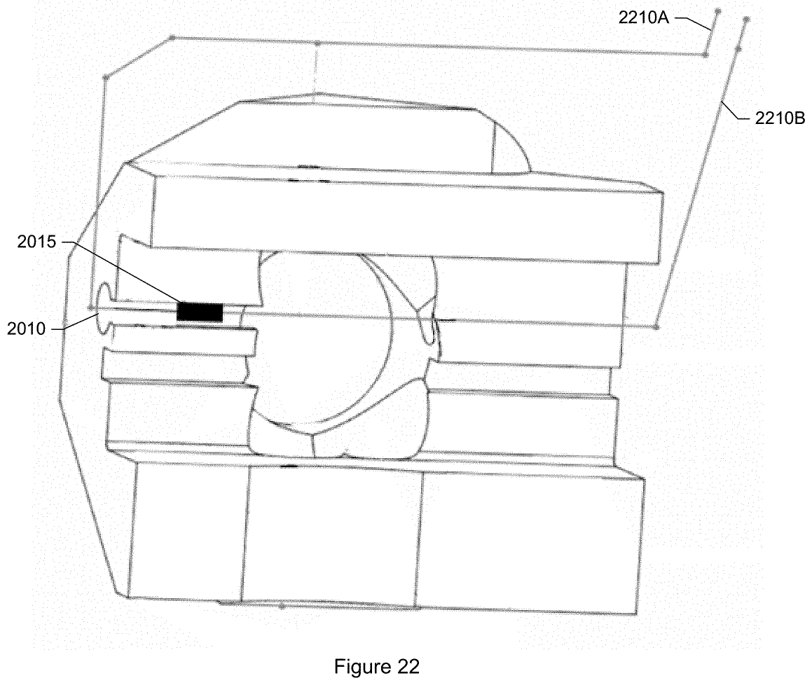

FIG. 22 shows an isometric view of the optical platform shown in FIG. 20. The view is from the bottom of the optical platform to the top of the optical platform. As shown in FIG. 22, there is the local heater groove into which the local heater is secured, and electrical connections 2210A,B to connect the heater to the circuit board, processor, power supply, and other electrical components. Here “groove” of “local heater groove” is to be interpreted broadly as any recessed cavity that can receive the local heater. In an embodiment, the heater is embedded into an area of the optical platform above the cartridge well. In this embodiment, the heater is recessed into the optical platform. That is, the heater sits below a surface of the optical platform above the cartridge well. In another embodiment, the heater may be arranged so that it sits flush with the surface of the optical platform above the cartridge well. In another embodiment, the heater may be arranged so that it sits proud of or protrudes from the surface of the optical platform above the cartridge well.

The heater insulating sleeve, as shown in the examples of FIGS. 15-19 and described in the accompanying discussion, is arranged to reduce heat transfer to the optical platform. That is, the heater is positioned in the optical platform so that the insulating sleeve is between the material of the optical platform and the axial resistor. The heater opening in the insulating sleeve, however, is positioned to face opening 925B of the collection cartridge, thereby promoting heat transfer to the air space surrounding the drying zone or beginning portion of the inspection zone and thus remove or reduce condensation from the tape media and collected particles before the collected particles are imaged by the camera sensor.

Compared to a global heater, a small carefully placed local heater greatly reduces power requirements. Reduced power means longer battery life and less expensive electronics. For example, the inventors calculate that if at least 50% of heat from the local heater goes into the air, and the above air flow rate is under one-half liter per minute, then 100 mW of electrical energy delivered to the local heater is sufficient to raise the air temperature by 5° C. This low power requirement avoids the need for special power electronics. Instead, it is sufficient to power the local heater with a few general-purpose input/output (GIO) pins of common microprocessors; for example two GIO pins of a Raspberry Pi. Impact on battery life can be further reduced or minimized by turning on the heater only when needed.

One method to determine when heating is truly needed (and hence reduce or minimize power consumption) is to process humidity (and temperature) measurements from sensors inside and/or outside the monitor housing. In addition, or instead, image processing software (perhaps using artificial intelligence) may be used to identify water droplets and turn on the heater when such negative effects due to condensation is observed in the optical data. It may not be necessary to thoroughly dry particles of interest in the particle inspection zone, it is sufficient to remove enough moisture so that good optical data may be collected.

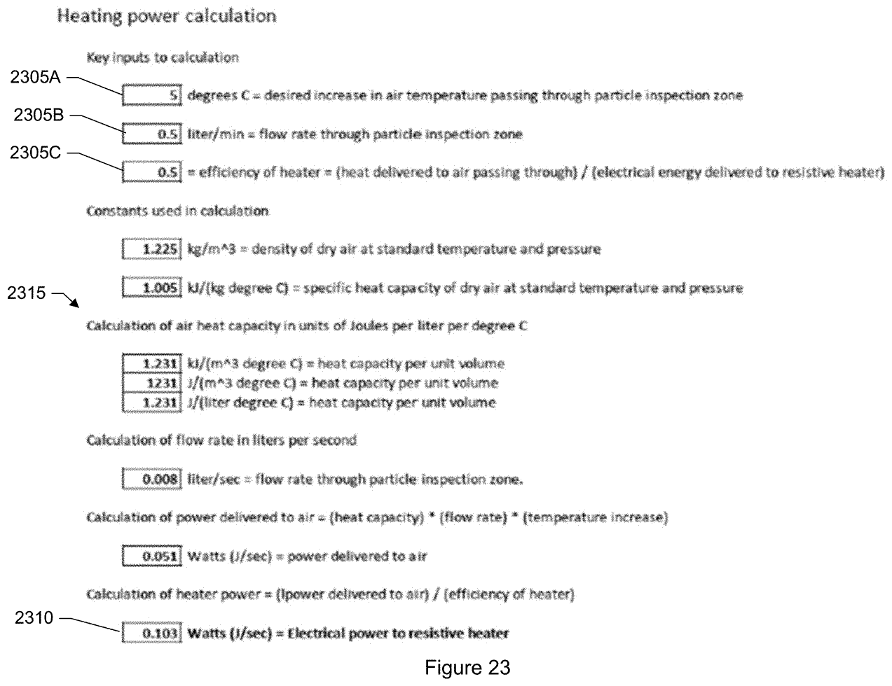

FIG. 23 shows a spreadsheet calculation for electrical power requirements of a local heater according to one or more embodiments. Boxes 2305A-C boxes contain key inputs to the calculation. The first is the desired increase in air temperature to avoid condensation, for example, 5 degrees Celsius. The second is the air flow rate through the particle inspection zone, for example, 0.5 liter per minute. The third is the efficiency with which electrical energy delivered to the heater is transferred to air flowing through the particle inspection zone, for example, 50%. A last box 2310 is the computed required electrical power of the local heater, which is 103 mW for the example key inputs. Other boxes 2315 contain values from intermediate steps of the calculation.

Table A below shows spreadsheet calculation results for a few different choices of key inputs.

TABLE A

| Temperature increase | Flow rate | Efficiency | Power required |
|---|---|---|---|
| 5 degrees Celsius | 1 liter/minute | 20% | 513 mW |
| 5 degrees Celsius | 1 liter/minute | 50% | 205 mW |
| 5 degrees Celsius | 0.5 liter/minute | 50% | 103 mW |
| 2.5 degrees Celsius | 0.5 liter/minute | 50% | 51 mW |

For any given application environment, the precise temperature increase required to avoid condensation may be determined from experiment. The values of flow rate and efficiency inputs are strongly influenced by engineering choices.

The power requirements scale with the air flow rate through the particle inspection zone. Power requirements may be reduced by reducing this flow rate. Methods for doing so are discussed below.

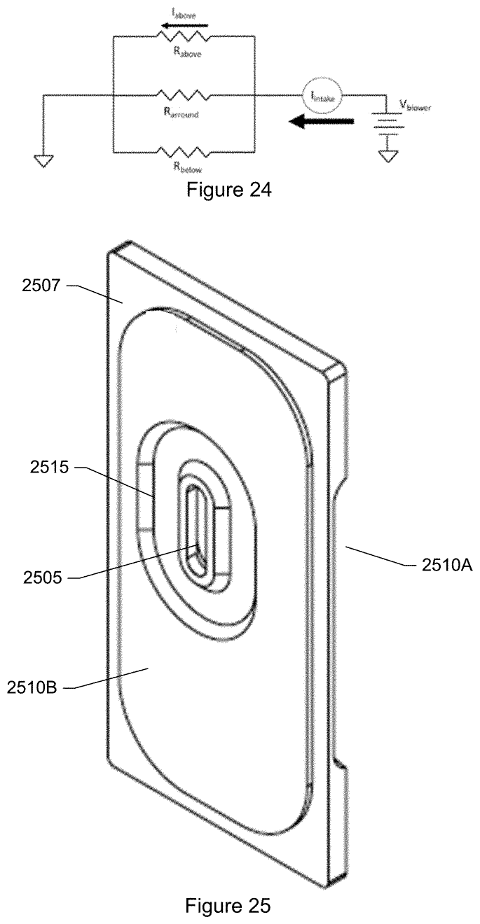

As shown in the example of FIG. 12, input air flow is being split between above air flow, around air flow and below air flow. FIG. 24 shows an equivalent circuit where V_{blower} represents the pressure difference between outside and inside air due to the blower, Iᵢₙₜₐₖₑ is the rate that ambient area is sampled in units of, for example, liters per minute. R_{above}, R_{around}, and R_{below} represent the resistance to air flow encountered by the various internal streams of air. I_{above} is the air flow of interest through the particle inspection zone.

For a given application, the rate ambient air is sampled, Iᵢₙₜₐₖₑ is often specified. For example, it may be specified at 10 liters per minute and the pressure difference due to the blower, V_{blower}, engineered accordingly. The fraction of the sampled ambient air that passes through the particle inspection zone, I_{above}, via the above air flow is determined by the following relationship.

$${I}_{above} = \frac{1 / {R}_{above}}{1 / {R}_{above} + 1 / {R}_{around} + 1 / {R}_{below}} \cdot {I}_{intake}$$

The formula above tells us that for a fixed ambient air sampling rate, Iᵢₙₜₐₖₑ, the flow rate through the particle inspection zone, I_{above}, may be reduced by either increasing resistance to above air flow, R_{above}, or decreasing resistance to other air flows such as the around air flow resistance R_{around}.

Referring back now to FIG. 12, a constricting gap 1251 encountered by the above air flow is highlighted with a pair of dashed arrows. Reducing this gap will increase the value of R_{above}, as will other further constrictions in the above air flow path such as added baffles.

As noted above, I_{above} can be reduced (thus reducing local heater power requirements) by decreasing R_{around}. Adding concave indents around the air intake slot is one way to do this. FIG. 25 shows an isometric view near a door portion of the detector housing showing an air-intake slot 2505. A housing 2507 of the detector includes an exterior side 2510A and an interior side 2510B, opposite the exterior side. The interior side includes a concave indentation 2515 formed on the interior side and surrounding or encircling at least a portion of the air-intake slot. In another embodiment, a heater is on the housing section with air intake slot.

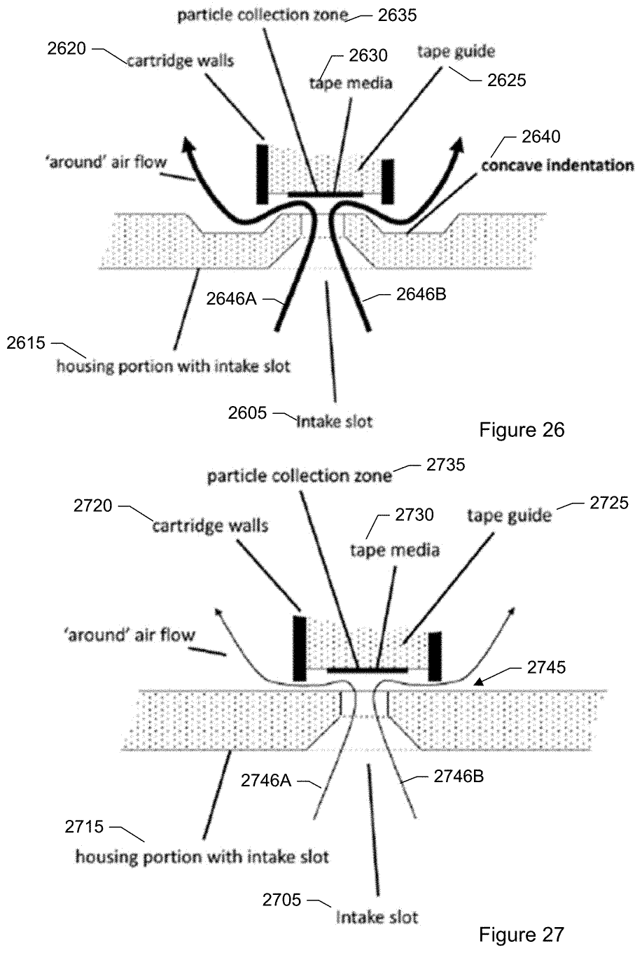

FIG. 26 shows a horizontal cross-section of housing and cartridge portions near an air-intake slot 2605 according to a specific embodiment. As shown in the example of FIG. 26, there is a housing portion with intake slot 2615, cartridge walls 2620, tape guide 2625, tape media 2630, a particle collection zone 2635 facing the air-intake slot, and concave indention 2640 formed about the air-intake slot on an interior side of the housing. Arrows 2646A,B indicate the flow of “around” air flow.

FIG. 27 shows a horizontal cross-section of housing and cartridge portions near an air-intake slot 2705 according to another specific embodiment. FIG. 27 is similar to FIG. 26. For example, there a housing portion with intake slot 2715, cartridge walls 2720, tape guide 2725, tape media 2730, and a particle collection zone 2735 facing the air-intake slot. Arrows 2746A,B indicate the flow of “around” air flow. In the example shown in FIG. 27, however, an inside surface 2745 surrounding the air-intake slot is flat.

Compare the two sketches shown in FIGS. 26 and 27 of the horizontal cross-section of portions of the housing (or housing door) and media cartridge near and including the air intake slot. In FIG. 26, concave indent on the inside of the housing reduces constriction of around air flow. The concave indentations reduces the ratio of Iabove to Iintake and also increases the rate of ambient air sample (i.e., increases Iintake).

The above discussion considers the case that the local heater is a resistor. In another embodiment, the particle collection zone may be heated with an infrared radiation source. For this purpose, an infrared illumination source may be added to the optical platform. For example, instead of illuminating the particle inspection zone with three white LEDs and an UV LED, it may be illuminated by three white LEDs, an UV LED, and an infrared illumination source. Before image capture, the infrared illumination source may evaporate any water droplets in the particle inspection zone as well as dry out any overly moistened particles of interest. The desired infrared illumination source is small in size and provides a well-directed beam of infrared “heat.”

Hardware Components To Reduce Or Eliminate Condensation—Desiccation

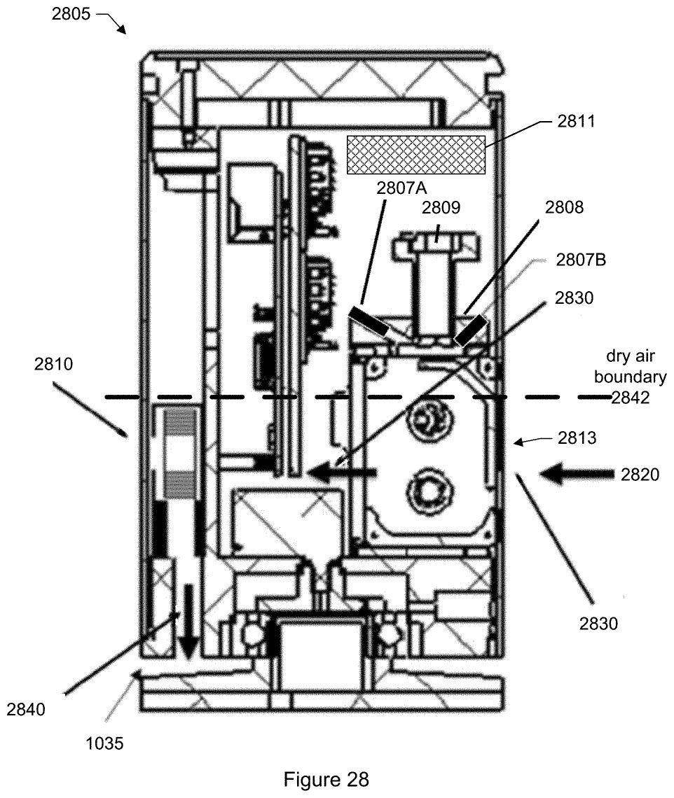

FIG. 28 shows an inside side view of a detector 2805 according to another specific embodiment. The detector shown in FIG. 28 is similar to the detector shown in FIG. 10. For example, there are light or radiation sources (e.g., LEDs) 2807A,B) mounted in an optical platform 2808, and a camera sensor 2809.

The detector shown in FIG. 28, however, includes a desiccator 2811 to control condensation. Desiccation methods discussed below may be used instead, or in addition to, the heating methods discussed above. FIG. 28 shows a vertical cross section of a particle monitor or detector. A desiccator, indicated by a shaded box, is added for the purpose of reducing humidity inside the device relative to the ambient humidity outside the device. The desiccator may be, for example, a package of silica gel. If sufficient water vapor is removed from inside air, the inside relative humidity drops well below 100%. This halts condensation and enables evaporation of existing droplets.

Desiccating of a lower portion 2813 of the device may be rendered difficult by the constant flow of moist ambient air 2820 through an air-intake slot 2830, past the particle collection zone, through the cartridge as indicated by internal air arrow 2830, 2840 and on through a blower 2810 to an exhaust 1035. It may be sufficient that the desired reduced humidity is provided in the vicinity of the particle inspection zone. This sufficient condition may be met, for example, if the desiccator results in dry air above a “dry air boundary” 2842 indicated in FIG. 28, even if air below the boundary remains moist.

If periods of high ambient relative humidity are brief interruptions within much longer periods of lower relative humidity, saturation of the desiccator may be avoided. The longer periods of lower relative humidity may dry out the desiccator sufficiently to function through the next brief period of high relative humidity. If not, means may be provided to dry out the desiccator.

For example, a heating element may be provided (as shown above) to rapidly and temporarily heat and dry out the desiccator.

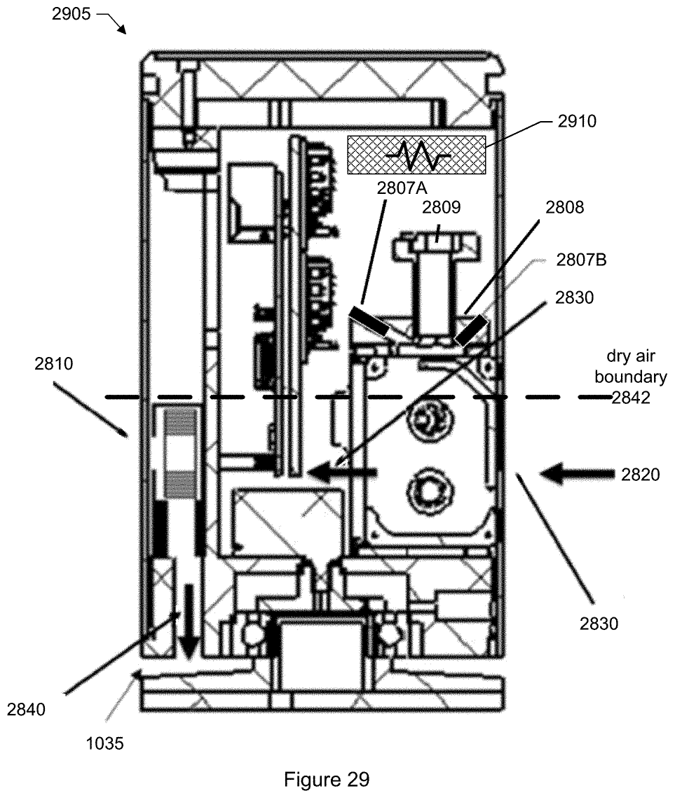

FIG. 29 shows an inside view of a detector 2905 according to another specific embodiment. The detector shown in FIG. 29 is similar to the detector shown in FIG. 10. The detector shown in FIG. 29, however, includes a desiccator with heater 2910.

In another embodiment, the detector may include hydrophobic and hydrophilic surfaces. In some applications, it may be desirable for particle collection/inspection surfaces to be hydrophilic. This does not prevent condensation and may even increase it, but will encourage condensation to take the form of a more uniform film rather than isolated droplets. This may be less distracting for optical image processing. This is analogous to scuba divers applying hydrophilic coatings to the inside of diver masks to prevent them from fogging up; condensation still occurs, but in a thin film that does not affect visibility.

Hardware Components To Reduce Or Eliminate Condensation—Air Flow

If condensation is caused by the detector being at a lower temperature than ambient air, such as when greenhouse air warms in the morning sun faster than the detector, then increasing air flow may help the detector reach ambient temperature. Once the detector reaches ambient temperature, condensation is less likely.

Increasing air flow through the device (e.g., by increasing electrical power to the blower) increases heat transferred from ambient air to the device. Part of this is simple heat conduction from the warmer air to cooler parts of the device. This may be enhanced by the heating effects of condensation. The latent heat released as water vapor becomes condensed water also heats the device.

Increasing air flow may well temporarily increase condensation. By enabling the device to more quickly reach thermal equilibrium with ambient air, increased air flow shortens the time during which optical data is compromised by condensation effects. It is a bit like ripping off a band-aid quickly rather than slowly in order to get the pain over with sooner. For some applications, this may be a useful method for reducing down time due to condensation.

In an embodiment, a condensation mitigation strategy includes an increase of air flow speed on to a particle collection zone. If the monitor has a variable speed blower that pulls air and particles through the intake and into the capture or inspection zone, a signal can be sent by the processor to increase the fan or blower speed to therefore accelerate air flow through the system which leads to achieving a faster equilibrium of the system where temperatures balance between inside and outside the system. At first this may seem contradictive because more air flow will cause more condensation on the surface of the inspection zone, but at the same time it accelerates the internal system achieving temperatures outside of the condensation window. In the case of an initial large temperature difference between the monitor and humid ambient air for example, it accelerates thermal equilibrium of the system decreasing the likelihood of condensing drops forming on the inspection zone surface.

Processes To Recognize And Reject Water Droplets In Images

Water droplets on a surface tend to have an axis of rotational symmetry. (Synonyms for rotational symmetry are “cylindrical symmetry” and “axial symmetry”.) The axis of symmetry goes or passes through the center of the droplet and is perpendicular to the surface. If the surface is horizontal, then the axis of rotational symmetry is vertical. Due to surface tension, water droplets have smooth rounded surfaces with strong specular reflections. The rotationally symmetric smooth rounded shape of water droplets leads to distinctive optical signatures. These distinctive signatures be used to recognize and reject water droplets in the optical data of airborne particle detectors.

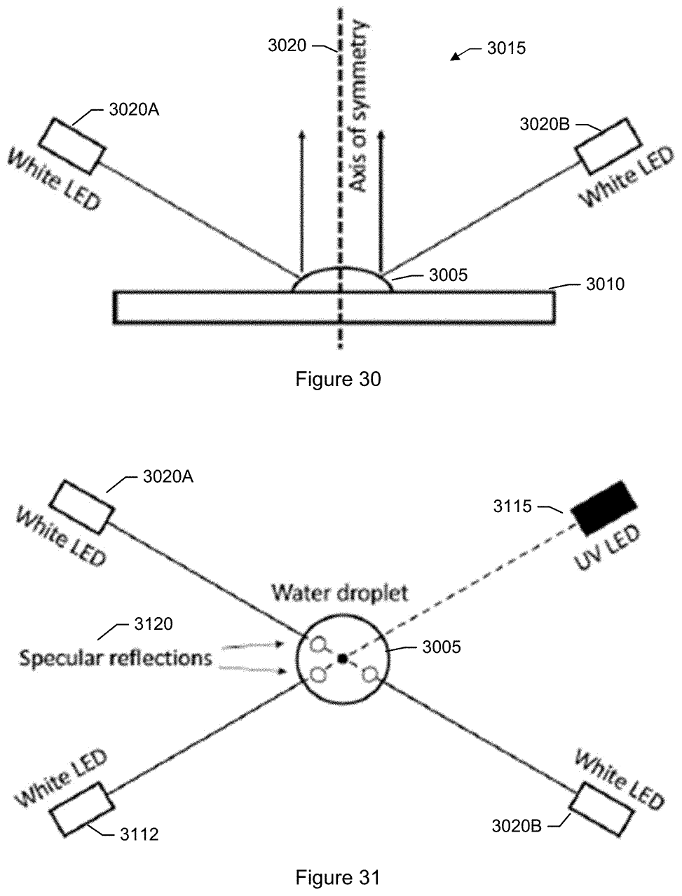

Let's first look at how these principles apply to optical data from a detector device having a lens-based microscope. FIG. 30 shows a side-view of a water drop 3005 on a collection surface 3010 that has been transported to a particle inspection zone 3015, that is, within the horizontal field of view of the microscope. As indicated, the water droplet has a vertical axis of rotational symmetry 3020. This symmetry axis is close to and parallel with the optical axis of the optical column of lens system (not shown) and camera sensor (not shown). For our purposes here, to a good approximation, we assume that the droplet axis of symmetry coincides with the optical column axis.

Light sources, such as first and second white LEDs 3020A,B are positioned about the particle inspection zone so as to illuminate the particle inspection zone or otherwise direct light to particles brought to the particle inspection zone. In an embodiment, white light LEDs illuminate the water drop as shown. Portions of the smooth rounded surface of the water droplet are at just the right orientation to reflect white LED light into the optical column. This reflection is specular, that is, mirror like.

FIG. 31 shows a plan view of the arrangement shown in FIG. 30. As shown, there are three white-light LEDs (3020A,B and 3112) illuminating the water droplet from different directions. There is also a single ultraviolet (UV) LED 3115, but it is not relevant to the current discussion concerning specular reflections. The reason is because, in an embodiment, the optical system of the detector is insensitive to specular reflection of UV light, responding only to visible light from UV excited fluorescence.

Specular reflection of light 3120 from the three white LEDs appears as three small bright spots in the camera sensor images. Due to the water droplet's smooth rounded and rotationally symmetric shape, these specular reflections provide a distinctive signature.

As drawn in FIG. 31, each specular reflection is located on a line between a white LED and the center of the water droplet. This would not be true if the water droplet were not rotationally symmetric. For example, spores do not behave this way. Furthermore, if the angle between the axis of the optical column and each of the white LED beams is the same, then the distance from the center of the droplet to each specular reflection is the same. This is the case for one or more embodiments of a detector device. In any case, for water droplets, the geometric arrangement of the three specular reflections as observed by the optical system is highly reproducible and largely determined by the placement of the three white LEDs.

In the above discussion, it is assumed that during image capture, all three white LEDs are activated, resulting in three specular reflection spots. Images may also be collected with illumination from two or only one white LED. Illumination with only one white LED will produce only one specular reflection spot, which is a less distinctive optical signature. For the purpose of recognizing (and rejecting) water droplets, it is preferable to capture images using two and more preferably three white LEDs. In an embodiment, an airborne particle detector includes more than three white LEDs thus providing water droplets with even more unique optical signatures. However, with three white LEDs, the optical signature of water droplets is already very distinctive and useful. If the illumination source forms a ring about the optical system axis, then the specular reflection will take the form of a circle.

To accentuate the optical signature of water droplets, illumination conditions may be changed. For example, one may take advantage of the brightness in camera sensor images of specular reflection spots on water droplets. By significantly reducing the illumination intensity of the white light LEDs of FIGS. 30 and 31 (and perhaps not activating the UV LED), the bright specular reflection spots of water droplets may remain clearly visible in camera sensor images while other objects in the field of view may fade to black. For subsequent image processing, such images with other distracting detail removed from specular reflections off water droplets may simplify recognition of optical signatures of water droplets, resulting in more reliable recognition of water droplets. Indications of a risk of condensation may trigger such a temporary change in illumination for optimal water droplet detection. Once the presence or absence of water droplets has been determined, illumination conditions may then be reset for optimal detection of particles of interest. Optimal illumination conditions for particle classification may depend on moisture conditions. This is one of many scenarios in which varying moisture conditions may lead to varying illumination conditions.

Processes For Moist Spore Reference Library

A more subtle countermeasure involves the reference particle features used to recognize particles of interest. For example, for a given species of spore, the characteristics of a moist spore may be different than the characteristics of a dry spore. When no water droplets are present, the particle recognition software may use reference characteristics for dry spores while when many water droplets are seen in images, the particle recognition software may use instead reference characteristics for moist spores. Similar concepts apply to detection of dry or moist pollen grains, or any other type of particles of interest whose characteristics change with moisture. These concepts are explained further below.

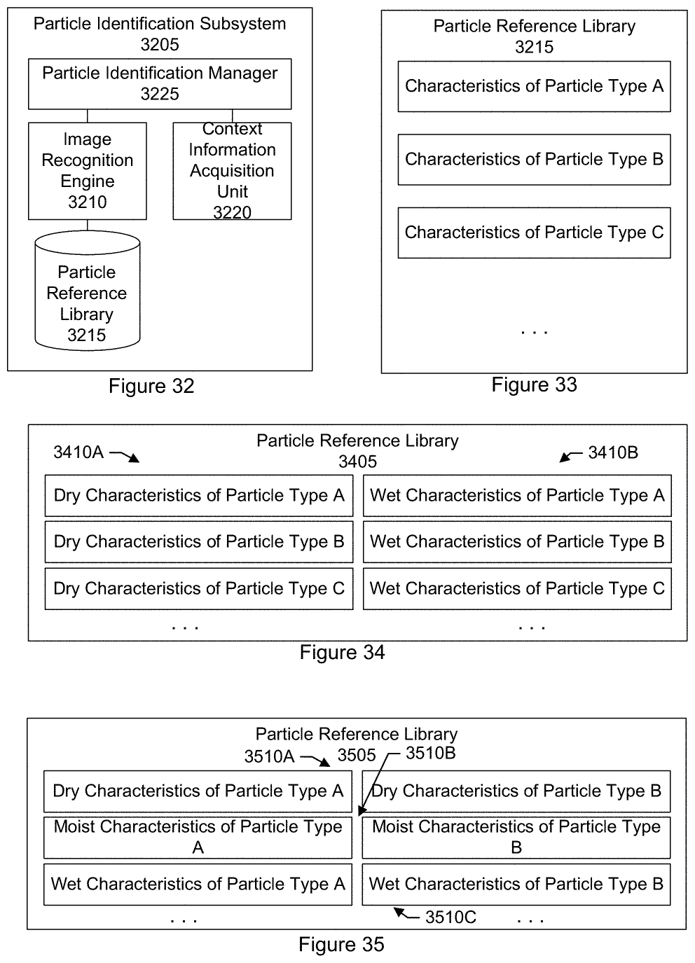

FIG. 32 shows a block diagram of a particle identification subsystem 3205 of a particle detector according to one or more embodiments. In an embodiment, the particle identification subsystem includes an image recognition engine 3210, particle reference library 3215, and context information acquisition unit 3220. A particle identification manager 3225 manages the particle identification or discrimination process. FIG. 33 shows further detail of the particle reference library according to one or more embodiments. For each type of particle of interest, a set of reference characteristics is stored in the particle reference library and made available to the image recognition engine. Additional discussion of the particle identification subsystem is provided in U.S. Pat. No. 9,933,351 mentioned above.

Problems may arise if the particle reference library contains characteristics of dry particles while the image recognition engine is processing optical data for moist or wet particles. This can lead to false negatives in which, say, particles of type A are present but not recognized because water has changed their characteristics. This false negative problem may be addressed by having a particle reference library that includes both dry and wet characteristics of particles types of interest.

FIG. 34 shows a block diagram of a particle reference library 3405 storing first characteristics (e.g., dry characteristics) 3410A for a set of particles and second characteristics (e.g., wet characteristics) 3410B for the set of particles.

In some applications it may be desirable during moist conditions to remove the dry characteristics of particles from the particle reference library, or otherwise constrain the image recognition engine to use only wet characteristics. Eliminating unneeded characteristics from the particle reference library may reduce the rate of false positives.

The particle moisture state may be spilt into more categories than simply dry or wet. As shown in the example of FIG. 35, a particle reference library 3505 may separately store characteristics of particles of interest for dry conditions (lower RH) 3510A, moist conditions (higher RH but not condensing) 3510B, and wet conditions (condensing) 3510C. RH refers to relative humidity. RH less than 100% is non-condensing. RH greater than 100% is condensing. To minimize or reduce false negatives, it is important to include characteristics corresponding to ambient humidity conditions within the particle reference library. To minimize or reduce false positives, it may be desirable to avoid using characteristics not corresponding to ambient conditions.

Referring again to FIG. 32, the particle identification subsystem 3205 may take advantage of modern techniques of machine learning, artificial intelligence and related algorithms such as anomaly detection algorithms (sometimes described as “outlier detection algorithms”). These modern techniques may be used in the construction of particle reference library 3215. These modern techniques may also be used by the image recognition engine 3210. For example, anomaly detection algorithms may be used to clean data of outliers before computing, e.g. “Characteristics of Particle Type A” of FIG. 33. As another example, machine-learning techniques may be used to tune a neural network that identifies any matches between particles in live sensor camera images and particle characteristics in the particle reference library 3215. In addition to recognition of particles of interest, machine learning, artificial intelligence and related algorithms may also be used in the detection of condensation conditions, and decisions in the response to condensation conditions.

In an embodiment, the processor of the particle detector is communicatively coupled to storage within which the particle reference library is maintained. In an embodiment, the particle reference library is maintained on a storage device local to the particle detector. For example, the particle reference library may be stored on a nonvolatile storage device contained within the housing of the particle detector or attached as an accessory to the particle detector. Examples of nonvolatile storage include hard disk or solid-state storage (e.g., flash, or USB flash drive plugged into a USB port of the particle detector). In another embodiment, the particle reference library is maintained on a central storage system, remote from the particle detector. In this embodiment, the particle detector includes a network interface to connect the particle detector to the remote central storage system via a network. The network may include a local area network, wide area network, wireless network, the Internet, or any other suitable communication network.

The particle characteristics stored in a particle reference library, such as particle reference libraries 3215, 3405 and 3505 of FIGS. 32 through 35, may be determined from optical images that are two-dimensional images. In an alternate embodiment, particle characteristics in particle reference libraries are derived from three-dimensional images of particles.

To capture three-dimensional images, referring to FIG. 10, camera sensor 1025 may capture a sequence of two-dimensional images with lens 1028 sequentially adjusted to a set of different focal depths, thus generating three-dimensional particle images with depth as well as length and width. Instead of adjusting lens focal length, the inspection surface may be moved to a set of incrementally different distances from the optical system. In yet another embodiment the camera sensor 1025 is a light field camera sensor that more directly captures three-dimensional image data. There are many ways to generate three-dimensional image data for particles of interest.

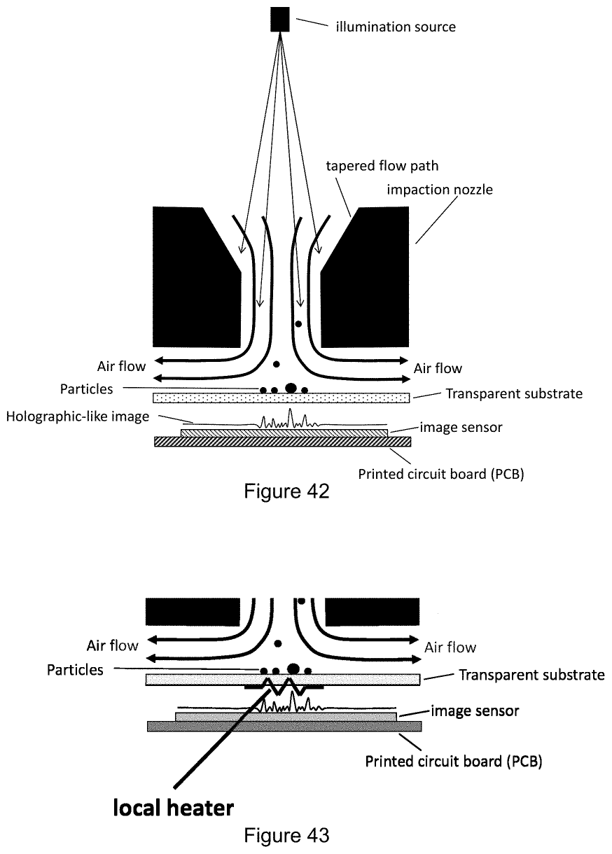

The optical system may have one or more lenses. Alternatively, the optical system may be lens free. This possibility is discussed further below in connection with FIGS. 42 through 44. If there is no lens, there is no option to adjust focal depth via lens focal length. Nevertheless, with a lens-free optical system, there is still an option to collect a set of two-dimensional images containing three-dimensional image information by moving the inspection surface. Referring to FIG. 42, the image sensor may be moved incremental up or down with respect to the transparent substrate.

Three-dimensional image data may be monochrome, or may contain standard RGB (red-green-blue) color information, or may contain richer color information that may be described as “multi-spectral” or “hyper-spectral”. Enhanced color information provides further data from which to extract particle characteristics for particle reference libraries.

Image data with enhanced color information and/or three-dimensional information may enable improved analysis of water droplets, moisture or condensation content. This may further support implementation of the condensation or moisture countermeasures described elsewhere in the document.

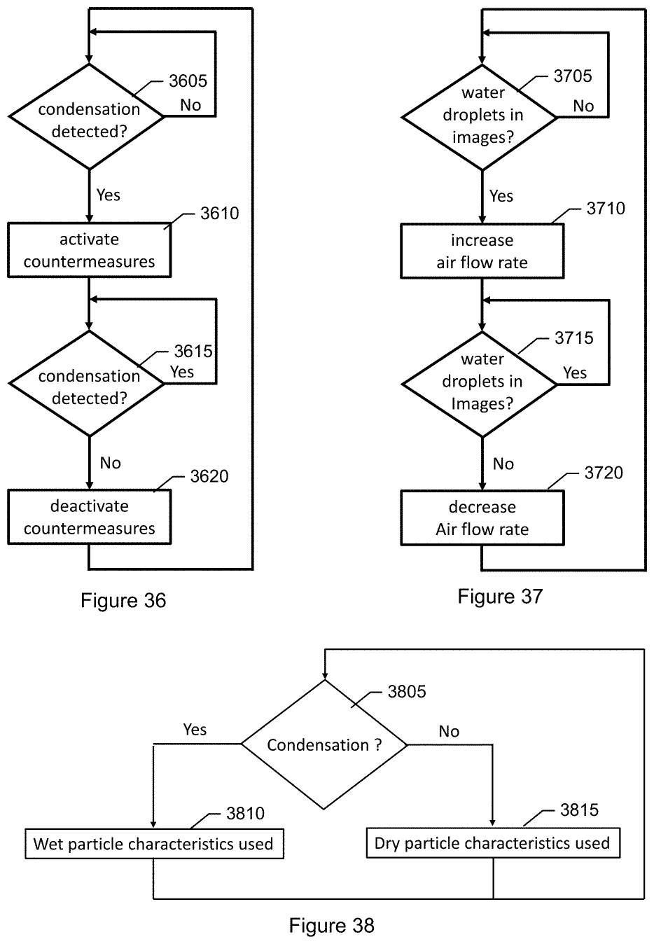

FIG. 36 shows an overall flow for activating countermeasures when condensation is observed and deactivating countermeasures when condensation is not observed. Some specific flows are presented in this application, but it should be understood that the process is not limited to the specific flows and steps presented. For example, a flow may have additional steps (not necessarily described in this application), different steps which replace some of the steps presented, fewer steps or a subset of the steps presented, or steps in a different order than presented, or any combination of these. Further, the steps in other embodiments may not be exactly the same as the steps presented and may be modified or altered as appropriate for a particular process, application or based on the data. It should be appreciated, in engineering implementations, the deactivation may be delayed (hysteresis) and activation may be based on a predictor of imminent condensation.

In brief, in a step 3605 a determination is made as to whether condensation is detected. If condensation is detected, in a step 3610 condensation countermeasures are activated. Condensation countermeasures may be maintained until no condensation is detected. For example, in a step 3615, another determination is made as to whether condensation is detected. If condensation is not detected, in a step 3620 condensation countermeasures are deactivated.

FIG. 37 shows a flow for a specific example of condensation being detected as the appearance of water droplets in camera sensor images and the countermeasure is an increase in air flow rate. In brief, in a step 3705 a determination is made as to whether there are water droplets in images. If there are water droplets in the images, in a step 3710, an air flow rate is increased. The increased air flow rate may be maintained until no condensation is detected. For example, in a step 3715, another determination is made as to whether there are water droplets in the images. If there are no water droplets in the images, in a step 3720, the air flow rate is decreased.

In an embodiment, the detection of water droplets in the camera sensor images triggers the heater (e.g., heater 1217, FIG. 12) to evaporate the water droplets. That is the processor may generate a signal to power on or turn the heater from an “off” state to an “on” state. The heater may be configured to remain in the “on” state for a predetermined threshold period of time, e.g., 5, 10, 15, 20, or 30 seconds, or for any other duration of time as desired. Once the threshold period of time has been reached, the processor may generate another signal to power off or turn the heater from the “on” state back to the “off” state. A new image of the collected particles may then be taken by the camera sensor. The new image may be again examined by the image recognition engine to detect whether any water droplets are remaining in the new image. If so, the evaporation process may be repeated until the water droplets have been evaporated. Once water droplets can no longer be detected, the image recognition engine may proceed to a process of identifying the collected particles.

In an embodiment, a method includes: collecting particles onto a tape media; advancing the tape media, including a section of the tape media having the particles, from a collection zone, past a heater, and to a particle inspection zone at which a first image of the particles is captured; detecting, from an analysis of the first image, that there are water droplets; rewinding the tape media, including the section of the tape media having the particles, to the heater; activating the heater for a threshold period of time; upon the threshold period of time being reached, deactivating the heater; advancing the tape media, including the section of the tape media having the particles, from the heater to the particle inspection zone; capturing a second image of the particles; analyzing the second image to determine whether any remaining water droplets can be detected; if there are water droplets detected, repeating the rewinding the tape media and activating the heater until there no remaining water droplets that can be detected; and if there are no remaining water droplets that can be detected, proceeding with an image analysis to identify the particles.

The above technique relies on image recognition or machine vision to detect the presence (or absence) of water droplets rather than climate sensors such as humidity sensors or temperature sensors. In an embodiment, such climate sensors can be omitted or excluded from the particle detector. Omitting such climate sensors can help to lower the overall cost of the particle detector and can facilitate a compact form factor.

In an embodiment, a method includes collecting particles from ambient air onto a section of tape media, the region of tape media being in a state having a first level of condensation; advancing the tape media, including the section of tape media having the particles, to a heater; activating the heater to reduce the first level of condensation to a second level of condensation, less than the first level of condensation; after the first level of condensation has been reduced to the second level of condensation, advancing the tape media, including the section of the tape media having the particles to a camera sensor; and capturing, via the camera sensor, an image of the particles while the particles are in a state having the second level of condensation.

In an embodiment, a method includes: activating a blower to draw, into a particle detector ambient air, and collect particles in the ambient air onto a tape media; advancing the tape media, including a section of the tape media having the particles, from a collection zone, past a heater, and to a particle inspection zone at which an image of the particles is captured; detecting, from an analysis of the image, that there are water droplets; activating the heater to warm a volume of air below the heater; and maintaining activation of the blower to draw the volume of warmed air to the particle inspection zone.

FIGS. 36 and 37 illustrate flows in which condensation countermeasures are automatically activated by the detection of some triggering condition. Alternatively, a human end-user may, in advance, pre-emptively program the device to deploy countermeasures at a specific date and time and duration. For example, the human end-user may pre-program countermeasures to activate during scheduled sprinkler irrigation of crops. Further reasons to pre-program condensation countermeasures may include scheduled chemical spray application, predicted rainfall or fog, and other known condensing and moisture inducing events. The end-user may pre-program the device to deploy countermeasures by remotely connecting through wireless techniques or by direct connection via a communications cable and protocol.

FIG. 38 shows a flow for determining whether to use wet particle characteristics or dry particle characteristics from a reference library to identify collected particles. In a step 3805, a determination is made as to whether condensation is present. If condensation is present, in a step 3810, wet particle characteristics are obtained from the reference library to use in identifying the particles. If condensation is not present, in a step 3815, dry particle characteristics are obtained from the reference library to use in identifying the particles.

This flowchart can be extended for more than two humidity states, such as dry, non-condensing moist, and condensing. The decision diamond of this process, includes processes to determine if condensation is occurring, or more generally to know ambient humidity conditions. Below are some examples of techniques that may be used either individually or in combination.

1) Observation of water droplets in optical data

2) Humidity and temperature sensors placed in ambient environment

3) Weather data on the internet or ‘cloud’ (for outdoor applications)

4) Quality of matches with reference particle characteristics (e.g., if detected particles better match reference data for wet particles than for dry particles, use reference library for wet particles)

An embodiment may include other condensation detection techniques instead of or in addition to any of the techniques listed above. In an embodiment, information correlated with condensation may be collected via image sensing (camera), a combination scatter light and UV fluorescence sensing, sensing of droplet disruption of total internal reflection of near infra-red light per methods of automobile windshield rain sensors, sensing humidity with a capacitive humidity sensor, and combinations of these and others that have the ability to discriminate the presence of condensation water droplets or condensing conditions. Such sensors may be placed within the particle inspection zone or may be placed at or between the particle collection zone and the particle inspection zone. A variant may be that one or a combination of these are used outside of the monitor and, or, in the vicinity as long as it is representative of what the particle sensor is experiencing (has been calibrated, etc).

Modern developments in computer science may provide more sophisticated methods for adapting to the effects of moisture and condensation on particles of interest. Smart software intelligence (machine learning, artificial intelligence (AI), deep learning, and so forth) may enable classification schemes that incorporate pre-taught training sets of particles subject to various moisture and condensation conditions.

Modeling—Predictive Rather Than Reactive

In some applications, it may be useful to take action, such as turning on a local heater, before condensation occurs. This motivates the development of predictive models that anticipate when condensation may occur. Such a predictive model may utilize a variety of inputs including measurements from humidity sensors and thermometers, the time of day, weather predictions, any evidence, or lack thereof, of humidity affecting particles in captured images, schedules for the turning on of sprinklers or sprayers. Predictive models may utilize a variety of computational methods including artificial intelligence and machine learning. Mitigating measures in response to predictions of condensation may be any of the condensation countermeasures discussed above.

In an embodiment, condensation countermeasures include reducing the time between particle capture and particle imaging, thus reducing the time available for condensation to occur. In embodiments using a tape media cartridge, the rate that the tape is advanced may be accelerated so that particles collected at the particle collection zone arrive more quickly at the particle inspection zone. In other embodiments not using a removable cartridge, and instead using a non-removable substrate surface that is transported from a particle collection zone to a particle inspection zone, the transit time can again be accelerated in order to reduce the time available for condensation to occur. Even if condensation is not completely eliminated, less condensation may lead to more accurate classification of particles. Like with other condensation countermeasures discussed above, this accelerated transit from collection to inspection zones may be activated by an intelligent operating system using predictive modeling and input information from various sources

Beyond Condensation

Some of the countermeasures described above are not limited to water droplets due to condensation, but may also apply to other sources of droplets or moisture such as agricultural sprays such as fungicide sprays. That is, in an embodiment, similar detection and mitigation strategies when the source of the water droplets is not condensation but fungal sprays and other liquid or aerosol type of chemicals that may come in and interfere with what is otherwise considered normal or regular operation of the system and therefore calls for hardware mitigation strategies and or different machine learning (ML)/artificial intelligence (AI) techniques may be deployed.

In an embodiment, the presence of water droplets touching and/or fully covering particles to be inspected is taken into consideration. In this case the detection of droplets or “undesired foreign” aerosols may trigger a different optical inspection scheme such that a specific wavelength may see through water while another one collects an ideal particle signature. It may also be that a dry spore model is subtracted from optical images or optical fingerprints as long as the amount of water or “foreign substance” is measured and a subtraction is performed to accurately classify the particles. The data captured here may be used to send these data or signals to an outer intelligence that helps control the environment where the monitor device is present or assuming locations have the same ambient characteristics these can be controlled/changed/altered/edited in their machine controls/etc using this data towards controlling any parameters that lead to undesirable ambient characteristics such as condensation, operating within a pathogen growth conducive environment or to help monitor further locations where these is to be prevented. In an embodiment, the data can run on a digital platform informing a user or another form of intelligence autonomous or semi-autonomous (limited human user input, but could also be a different intelligence tasked with a different purpose that overlaps to analyze and provide an input to a data set).

In some embodiments, captured images, or more generally optical inspection data, are processed to subtract or otherwise compensate for the effects of water condensation before comparing to a particle reference library (such as particle reference library 3215 of FIG. 33). For example, bright spots from specular reflection off capillary water surfaces may be removed before seeking matches with characteristics in the reference library.

In some embodiments, mitigation measures may include altering illumination used during image capture. For example, consider a case where under combined white-light and UV illumination the images are unduly corrupted by specular reflections of visible light from capillary water films forming around particles of interest (e.g. pollen grains). It this case, it may be advantageous to capture fluorescence images resulting from UV illumination only. As water does not fluoresce under UV illumination, this eliminates the capillary water film, and water droplets, from captured images leaving only the image of the (fluorescing) particles of interest. In addition to modified illumination, under condensing conditions, it may also be desirable to modify the processing of captured images. For example, red pixel data may be removed if the desired fluorescence signal is blue or green. In brief, how images are captured may be a function of moisture conditions.

In some embodiments, countermeasures may go beyond just adapting to ambient environmental conditions that lead to condensation, but actually changing the ambient environment itself. For example, a greenhouse system may include control of sprinklers, heaters, air ventilation including windows and fans, etc. When condensation conditions occur, or appear imminent, one or more of these greenhouse system controls may be altered. Anything that reduces or eliminates condensation is a possible countermeasure.

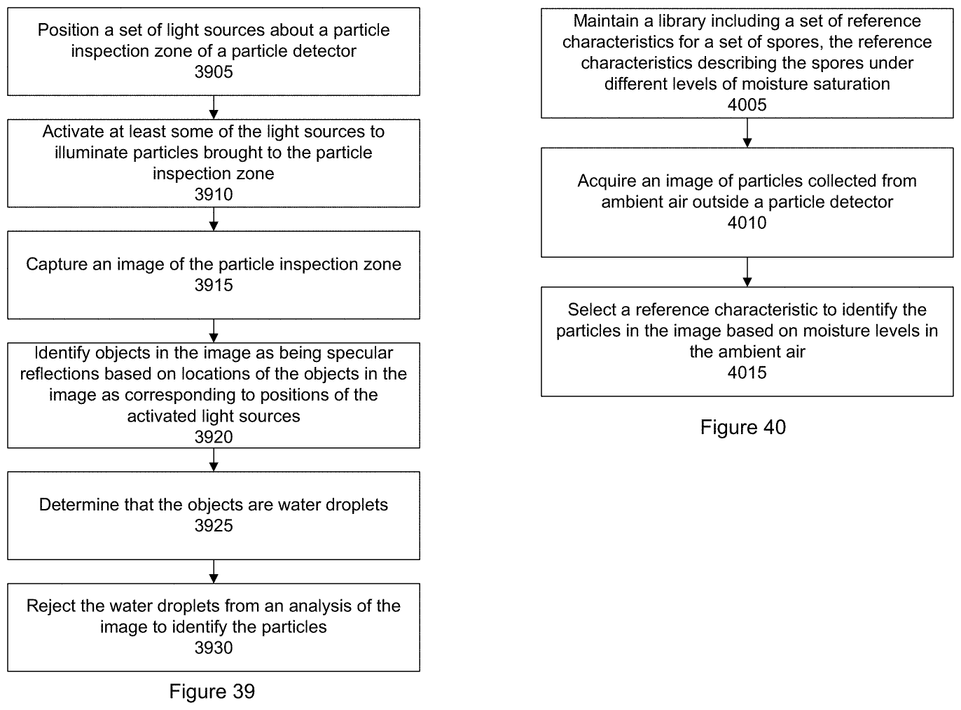

FIG. 39 shows another flow for addressing condensation according to one or more embodiments. In a step 3905, a set of light sources are positioned about a particle inspection zone of a particle detector. In a step 3910, at least some of the light sources are activated to illuminate particles brought to the particle inspection zone. In a step 3915, an image is captured of the particles at the particle inspection zone. In a step 3920, objects in the image are identified as being specular reflections based on locations of the objects in the image as corresponding to positions of the activated light sources. In a step 3925, a determination is thus made that the objects are water droplets. In a step 3930, the water droplets are rejected from an analysis of the image to identify the particles.

FIG. 40 shows another flow for addressing condensation according to one or more embodiments. In a step 4005, a library is maintained. The library includes a set of reference characteristics for a set of spores. The reference characteristics describe the spores under different levels of moisture saturation. In a step 4010, an image is acquired of particles collected from ambient air outside a particle detector. In a step 4015, a reference characteristic is selected to identify the particles in the image based on moisture levels in the ambient air.

In an embodiment, a detector device having condensation countermeasures may be particularly suited for greenhouse applications. In other embodiments, a detector device having condensation countermeasures also addresses needs for outdoor applications. Condensation may occur in outdoor/nature during a combination of rain and aided by hot winds. Hot winds subject to rain rapidly absorb water and become saturated. If such warm water saturated ambient air is drawn into a detector device whose interior is still cooler than ambient air, condensation will occur. Fog events are another circumstance when condensation within a detector device may be an issue. In brief, condensation countermeasures are relevant to both indoor and outdoor applications.

Here are some specific applications where condensation countermeasures are needed. Consider orchards, for example, in late summers in locations such as Napa, Calif. where the earth/soil gets very hot and rapidly evaporates moisture during the day. The temperature drops in the late afternoon and evening and continues dropping until the early morning sun rises and warms the canopy. As the temperature drops, a fog may form resulting in condensation conditions. Relevant applications are not limited to agriculture. For example, consider indoor mold remediation needed after a leaking water pipe is repaired. Again as temperature rises air absorbs moisture and then when temperatures drop condensation may occur. Other environments where suddenly surface condensation may occur are boiler rooms in industrial and transportation (cruise ships and large boats as examples) venues, kitchens, and near building entrances (doors and windows) with high pedestrian foot traffic (hotel entry/exit areas where doors and window may open and close). There are many applications where conditions are conducive to the condensation phenomena.

In some embodiments there is a monitor placed inside a vehicle. The vehicle may be autonomous and/or human operated. In certain circumstances, a monitor inside a vehicle may be subject to condensation. Particularly during cold winter days or hot summer days, the temperature of air within a vehicle can vary significantly as doors and windows open and close, and heaters or air conditioners are turned on and off. From time to time, the ambient air inside the vehicle may be considerably warmer than the interior of the monitor. Humidity conditions may also vary, such as when evaporation from snow covered or rain-soaked clothing dry out. When the ambient air inside the vehicle has high relative humidity and has a temperature exceeding the interior of the monitor, undesired condensation may well occur. Condensation countermeasures are of interest in applications in which monitors are placed inside vehicles.

Different particles of interest may react differently to condensation conditions. Water condensed on pollens tend to form a capillary layer. In contrast water condensing on fungal spores are more likely to be absorbed, impeding the formation of a capillary layer but distorting the shape of the fungal spore. Typically, fungal spores are much smaller (microns) than pollen grains (tens of microns). When the size of condensation droplets become larger than fungal spores, small fungal spores may be fully embedded inside a micron-sized condensation droplets.

For clarity of exposition, FIGS. 7 through 12, 20 through 22, 28 and 29 are all based on monitor designs with a lens-based microscope system and a removable cartridge. However, as is discussed below, the underlying condensation countermeasures principles illustrated with these figures are not so limited. In particular, the following generalizations are noted:
Particle capture surface may be single use (cartridge) or multi-use (cartridge-less), recycled inspection surface
Particle inspection optical information may come from a lens and, or, lens-less optical system
Note some instrumentation may not need particles to be captured, it could be that particles suspended in air are optically inspected as these “fly” across light beams resulting in the detection of scattered or fluorescently reemitted light. At first use of very high-speed cameras might not seem possible because particles are not confined to the camera's focal plane (there is no particle capture/inspection surface to focus on). However, with the development of light-field camera technology, it becomes possible in software to choose a different focus for each particle detected.

In an embodiment, one or more condensation countermeasures are implemented in an airborne particle detector having the ability to distinguish between different species of spores or pollen by collecting and interpreting optical data. The nature of optical data varies depending on the nature of the optical system hardware.

A specific embodiment of an airborne particle detector is a detector referred to as SporeCam® by Scanit Technologies of Fremont, Calif. The device can be deployed in indoor or outdoor growing environments to continuously capture airborne particles onto a media cassette. The device uses optics and light fusion to obtain data on particles captured. Data may be transferred to cloud servers (e.g., Amazon Web Services (AWS) servers) for analysis. The Scanit system enables detection of airborne pathogens before infestation so that growers can take preventive actions, optimize pest management practices, minimize yield losses, and have efficacy proof that their actions are working to control disease.

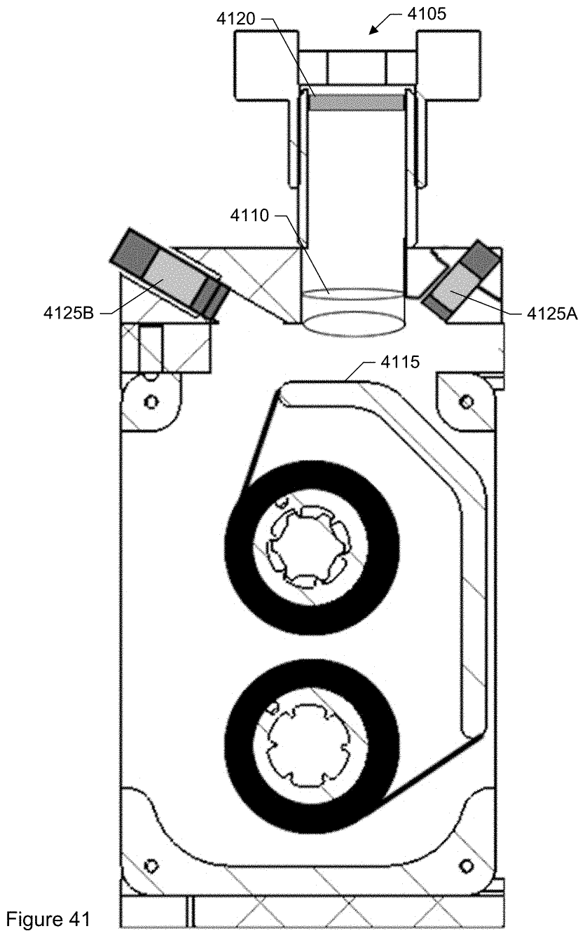

The optical system of Scanit devices may be described as a lens-based microscope. A lens system images particles in a particle inspection zone onto a camera sensor. For example, FIG. 41 shows an inside side view of a particle detector 4105 according to one or more embodiments. The detector includes a lens system or assembly 4110 that images particles in a particle inspection zone 4115 onto a camera sensor 4120. Light sources including first and second light sources 4125A,B illuminate the particle inspection zone during image capture. Current Scanit devices have four illumination sources. Three are white LEDs and the fourth is an UV LED. The UV LED is used for fluorescence image capture. For Scanit's lens-based microscope, the optical data takes the form of microscope images. A further discussion of the detector is provided in U.S. Pat. No. 9,933,351.

There are various implementations of systems and techniques to distinguish between different species of spores or pollens by collecting and interpreting optical data such as discussed in U.S. patent application Ser. No. 16/492,098 (Ozcan) and U.S. Pat. No. 6,594,001 (Yabusaki). While a specific embodiment of condensation countermeasures is directed to a detector having a lens-based microscope, it should be appreciated that the condensation countermeasures described can be applied to other detectors having other optical hardware including those of Ozcan and Yabusaki. That is, water condensation may compromise optical data from the optical systems of Ozcan, Yabusaki, and others; and the condensation countermeasures described may be applied to the Ozcan, Yabusaki, and other systems. A particle detector may be implemented using any one concept or combination of the concepts discussed in this document for condensation countermeasures. A condensation countermeasure as presented in this patent application may be modified as needed for the particular detector application.

For example, FIG. 42 shows a simplified representation of FIG. 4 in Ozcan. Particles in air flow through an impaction nozzle (having a tapered flow path) and are collected on a transparent substrate. An image sensor mounted on a printed circuit board (PCB) is placed below the transparent substrate. An illumination source illuminates the collected particles resulting in a holographic-like image being detected by the image sensor. After mathematical processing, a microscope-like image of the particles is produced. There is no lens in this system.

In other words, particles are collected on the surface of the transparent substrate. Captured particles are illuminated by the illumination source generating optical data at the image sensor. Unlike for Scanit optical systems, this optical system contains no lens. As schematically represented by the wavy line drawn above the image sensor, the resulting image is a complex interference pattern, not a direct image of the particles of interest. Nevertheless, with suitable mathematical processing, to a good approximation, such lens-less optical images can be transformed into images similar to images of a more conventional microscope.

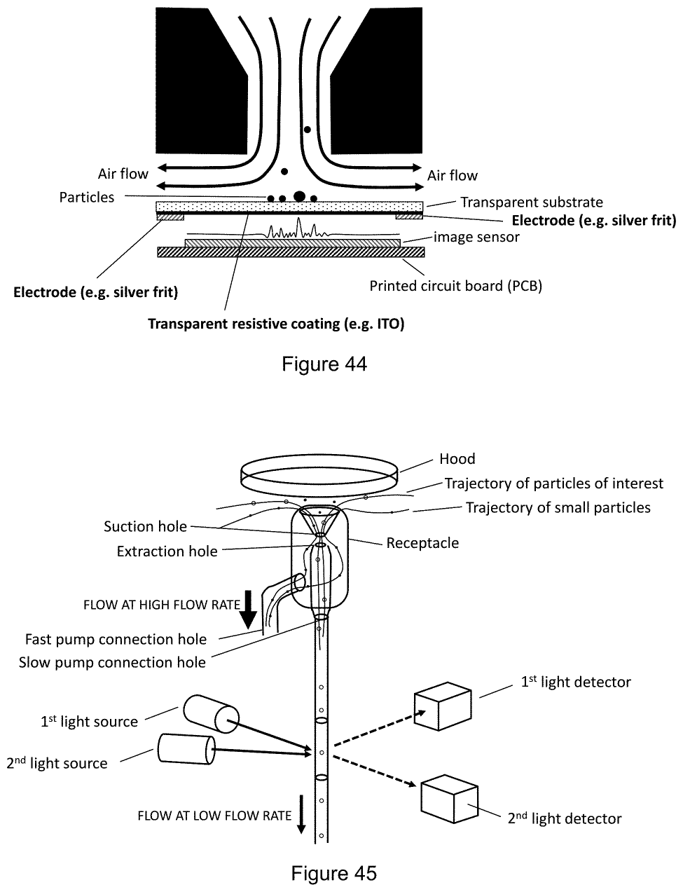

The above principles explained in terms of Scanit's optical system also may be applied to the optical system of Ozcan. FIG. 43 shows a portion of FIG. 4 of Ozcan. The Ozcan device has been modified by the addition of a local heater to the substrate where particles are collected and inspected. Heating the substrate will evaporate any water droplets, or prevent their formation, as well as dry particles of interest. One possible construction of such a local heater is a thin transparent conductive film, such as ITO (indium tin oxide), on the substrate such as shown in FIG. 44. Passing an electrical current through such a transparent conductive film will generate heat. In the automobile industry, it is known to defrost car windows by passing an electrical current through an ITO film coating the window glass.

As another contrasting example, consider the particle detection optics described in Yabusaki and assigned to Kowa. FIG. 45 shows a simplified representation of FIG. 6 in Yabusaki. Protected from rain by a hood, ambient air is drawn into a receptable with a virtual impactor. The virtual impactor separates larger particles of interest, such as pollen grains, from smaller background particles, such as smoke particles. Most of the sampled air passing through the suction hole does not enter the extraction hole, but rather is diverted at a high flow rate to a hole connected to a fast pump. Likewise, most small background particles are also removed by the fast pump. Due to their larger mass or inertia, the large particles of interest do not follow sharp bends in the air flow and instead have a high probability of entering the extraction hole, exiting the receptacle through a slow pump connection hole, and passing through a transparent tube. At a particle inspection zone, particles of interest are optically probed with one or more light sources and one or more light detectors. The light sources may be visible light sources, UV light sources, IR light sources or a combination of such types of light sources. The light sources may be LEDs, lasers, or any other type of light sources. The detectors may detect transmitted light, scattered light, and/or fluorescent light. The light detectors may include lenses, mirrors, chromatic filters as well as light sensors such as photomultiplier tubes, photodiodes, phototransistors and camera sensors. Particles of interest are optically probed while suspected in air (not on a solid surface).

In other words, unlike the Scanit and Ozcan devices, particles of interest are optically probed while still suspended in air within a flow cell. Ambient air is sampled and particles of interest are directed into a flow cell. Light from a light source illuminates particles of interest in the flow cell. Scattered or fluorescent light from particles of interest is detected by photomultiplier tubes. Unlike the Scanit and Ozcan systems described above, no 2-D images of particles are generated. Nevertheless, this Yabusaki optical system provides a degree of particle discrimination based on optical data that probes the optical scattering and fluorescence properties of particles.

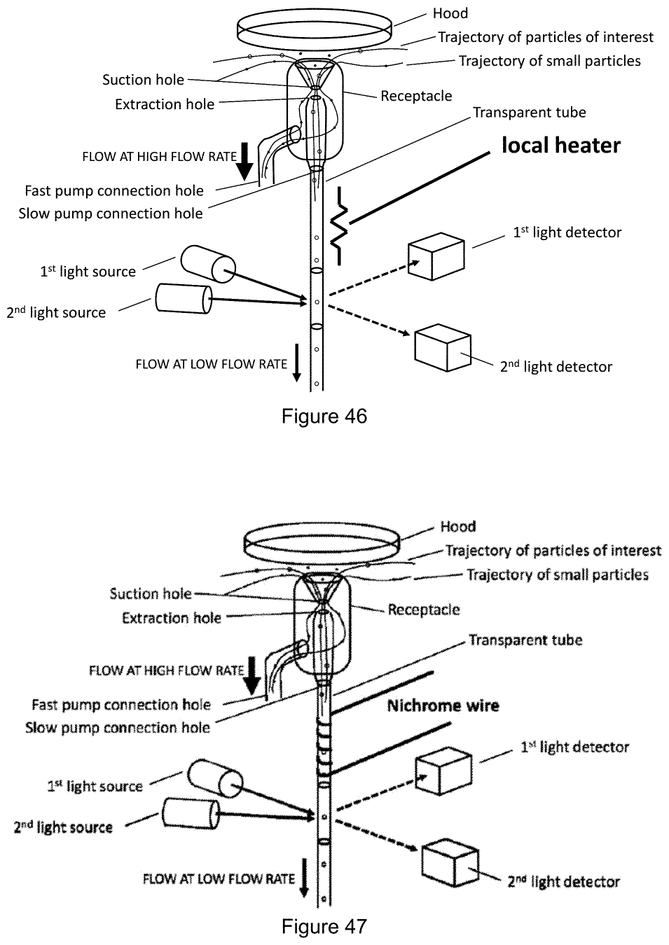

As conceptually illustrated in FIG. 46, a local heater may also be added to the particle monitor design of Yabusaki. A heating element in thermal contact with the upstream portion of the flow cell may sufficiently heat the flowing air so as to remove any water films or excess moisture from particles of interest before the particles are optically measured. For example, a resistive nichrome wire might be wrapped around the upstream portion of the flow cell as shown in FIG. 47. The small sizes of particles result in much faster drying times than expected from human intuition and experience with much larger wet objects.

Heating the interior of the device may reduce or eliminate condensation. Less heating energy may be required if a local heater aims only to elevate the temperature locally where particles are inspected.

Referring back now to FIG. 42, recognizing water droplets may likewise be applied to a lens-less optical system. For the lens-less optical system of Ozcan, it is still true that (to quote from above) “the rotationally symmetric smooth rounded shape of water droplets leads to distinct optical signatures.” However, now the distinct optical signature is no longer a set of three specular reflection spots. In fact, taking a close look at the above FIG. 42, it is doubtful that the image sensor will receive any specular reflections at all from water droplets on substrate under illumination of illumination source. Instead, we expect complex interference patterns from refracted and transmitted light.

In the Ozcan optical system, the signature of the rotationally symmetric smooth rounded shape of water droplets is a rotationally symmetric interference pattern. After mathematical processing to eliminate the interference patterns, the resulting droplet image is expected to remain at least approximately rotationally symmetric. This allows water droplets to flagged for rejection either before or after the mathematical processing.

For airborne particle detectors of the style of Yabusaki, water droplets are even more symmetric. Small water droplets suspended in air are spherical. This high degree of symmetry (rotational symmetry about any axis through the droplet's center) can be expected to result in a distinct optical signature. For example, the optical data after the droplet falls past the optical measurement plane may be a time-reversed copy of the optical data obtained as the droplet approached the optical measurement plane. The optical data for a tumbling non-spherical spore or pollen grain may be expected to produce optical data with more random variations. Here “small” of “small water droplets” means comparable to the size of pollen or spores. Raindrops are too “big” to enter the Yabusaki device. Raindrops are larger than 0.5 mm in diameter and as they fall take the shape of flattened spheroids.

The particle detector executes executable code (or computer-readable code) that embodies a technique or algorithm as described herein. For example, in an embodiment, the particle detector includes a processor, read only memory (ROM) connected to the processor and storing programs, data, images, or combinations of these. Random access memory (RAM) may be connected to the processor such as via a bus. The RAM provides a working storage space for the storage of particle images and data captured by the camera sensor. The processor may be further connected to the light sources, heater, cartridge motor, blower, and other hardware components of the particle detector. The processor may be programmed or configured using the programs and data stored in ROM to activate, deactivate, coordinate, communicate, and interact with these and other hardware components of the particle detector. The processor performs algorithms and directs the overall operation of the particle detector.

Such algorithms may, for example, govern operation of the blower to draw ambient air into the particle detector and towards the tape media of the collection cartridge; operation of the cartridge motor to advance the tape media containing collected particles from the collection zone, past the heater, and to the inspection zone; operation of the light sources to illuminate the particles; operation of the camera sensor to capture the illuminated particles; execution of image recognition logic to detect water droplets; operation of the cartridge motor to rewind the tape media from the inspection zone to the heater; operation of the heater to evaporate the water droplets; other operations as described and combinations of these.

In an embodiment, there is a particle detector (700, FIG. 7) comprising: an opening (730) into which ambient air outside the particle detector and comprising particles of interest to collect is drawn; a light source (1015A, FIG. 10); a heater (1217, FIG. 12); a sensor (1025, FIG. 10); and a processor (e.g., motherboard 1005 containing the processor), coupled to the light source, heater, and sensor, wherein the heater increases a temperature at a particle inspection zone at which the particles are brought relative to a temperature of the ambient air, the light source illuminates the particles with light, the sensor detects and generates optical data resulting from the particles being illuminated with the light, and the processor analyzes the optical data received from the sensor to identify the particles.

The heater may be positioned upstream of the particle inspection zone with respect to an air flow path (1245, FIG. 12). The heater may include an axial resistor (1305, FIG. 13), coupled to the processor; an insulating sleeve (1510, FIG. 15), containing the axial resistor, and having ends that are sealed; and an opening (1515) formed in the sleeve and exposing a portion of the axial resistor.

The opening of the particle detector may include an exterior side (2510A, FIG. 25); an interior side (2510B), opposite the exterior side; and a concave surface (2515) on the interior side and surrounding at least a portion of the opening. The particle detector may include a desiccator (2811, FIG. 28).

In an embodiment, the particle detector includes an optical platform (1210, FIG. 12), the optical platform comprising: a cartridge well (1026, FIG. 10) for holding a removable cartridge (805, FIG. 8), the removable cartridge having a first side (830), and a second side (840), adjacent to the first side, wherein when the removable cartridge is inserted into the particle detector, the first side faces the opening and the second side is at the particle inspection zone; and a groove (2010, FIG. 20) into which the heater is recessed.

In an embodiment, the light source is a first light source of a plurality of light sources (1015A,B, FIG. 10) arranged about the particle inspection zone and coupled to the processor, the processor configured to perform a method comprising: activating at least some of the plurality of light sources to illuminate particles brought to the particle inspection zone; activating the sensor to capture an image of the particle inspection zone; identifying objects in the image as being specular reflections based on locations of the objects in the image as corresponding to positions of the activated light sources; determining that the objects are water droplets; and rejecting the water droplets from an analysis of the image to identify the particles.

In an embodiment, the processor is communicatively coupled to a storage device (4917, FIG. 49) within which a library (3215, FIG. 32) comprising a plurality of reference characteristics for a plurality of spores is maintained, the reference characteristics describing the spores under different levels of moisture saturation, and wherein the processor is configured to perform a method comprising: acquiring, via the sensor, an image of particles collected from ambient air; and selecting a reference characteristic to identify the particles from the image based on moisture levels in the ambient air.

In an embodiment, the particle detector includes an optical platform (1210, FIG. 12) comprising: a cartridge well (1026, FIG. 10) for holding a collection cartridge (805, FIG. 8) within which the particles are collected, wherein the heater is coupled to the optical platform and positioned to be above the cartridge well. In an embodiment, the particle detector includes a lens (1028, FIG. 10), wherein the heater does not contact the lens.

In an embodiment, there is a method of operating a particle detector (700, FIG. 7) comprising: collecting particles from ambient air onto a tape media (915, FIG. 9) of a collection cartridge (805, FIG. 8); advancing a portion of the tape media having the collected particles to a particle inspection zone (840); and before the portion of the tape media reaches the particle inspection zone, applying heat to the portion of the tape media.

In an embodiment, the particle detector includes an optical platform (1210, FIG. 12) comprising: a cartridge well (1026, FIG. 10) for holding the collection cartridge; and a heater (1217, FIG. 12) for applying the heat, the heater being coupled to the optical platform and positioned to be above the cartridge well.

In an embodiment, the heater includes an axial resistor (1305, FIG. 13); an insulating sleeve (1510, FIG. 15), containing the axial resistor, to prevent heat transfer to the optical platform; and an opening (1515) formed in the insulating sleeve and exposing a portion of the axial resistor to promote heat transfer to air in the cartridge well.

In an embodiment, there is a particle detector (700, FIG. 7) comprising: a camera sensor (1025, FIG. 10); an optical platform (1210, FIG. 12) comprising: a cartridge well (1026, FIG. 10) to hold a collection cartridge (805, FIG. 8) comprising a tape media (915, FIG. 9), a collection zone (1230, FIG. 12) at which particles are collected onto the tape media, a drying zone (1250) at which condensation on the tape media and saturating the particles is evaporated, and an inspection zone (1242) at which the particles are imaged by the camera sensor; and a heater (1217) positioned to be above or at the drying zone of the collection cartridge, the heater comprising an axial resistor (1305, FIG. 13), an insulating sleeve (1510, FIG. 15) containing the axial resistor, and an opening (1515) formed in the insulating sleeve to expose a portion of the axial resistor to the drying zone; and an opening (730, FIG. 7), facing the collection zone, and through which ambient air flows in a flow path (1245, FIG. 12) from the collection zone to the drying zone to the inspection zone, wherein the heater is upstream of the particle inspection zone with respect to the flow path and generates heat to remove condensation from the tape media and collected particles before the collected particles are imaged by the camera sensor. The insulating sleeve is positioned to be between the axial resistor and a material of the optical platform, the insulating sleeve thereby being arranged to reduce heat transfer to the optical platform while promoting heat transfer to the drying zone.

In an embodiment, a particle detector includes: an opening into which ambient air outside the particle detector and comprising particles of interest to collect is drawn; a light source; a heater; a sensor; and a processor, coupled to the light source, heater, and sensor, wherein the heater increases a temperature at a particle inspection zone at which the particles are brought relative to a temperature of the ambient air, the light source illuminates the particles with light, the sensor detects and generates optical data resulting from the particles being illuminated with the light, and the processor analyzes the optical data received from the sensor to identify the particles.

The heater may be positioned upstream of the particle inspection zone. The heater may include: an axial resistor, coupled to the processor; an insulating sleeve, containing the axial resistor, and having ends that are sealed; and an opening formed in the sleeve and exposing a portion of the axial resistor. The opening may include: an exterior side; an interior side, opposite the exterior side; and a concave surface on the interior side and surrounding at least a portion of the opening. The particle detector may include a desiccator.

In an embodiment, the particle detector includes an optical platform, the optical platform comprising: a cartridge well for holding a removable cartridge, the removable cartridge having a first side, and a second side, adjacent to the first side, wherein when the removable cartridge is inserted into the particle detector, the first side faces the opening and the second side is at the particle inspection zone; and a groove into which the heater is recessed.

In an embodiment, a particle detector includes: an opening into which ambient air outside the particle detector and comprising particles of interest to collect is drawn; a light source; a desiccator; a sensor; and a processor, coupled to the light source and sensor, wherein the light source illuminates the particles with light, the sensor detects and generates optical data resulting from the particles being illuminated with the light, the processor analyzes the optical data received from the sensor to identify the particles, and the desiccator reduces humidity inside the particle detector relative to humidity in the ambient air outside the particle detector device.

In an embodiment, a method includes: positioning a plurality of light sources about a particle inspection zone of a particle detector; activating at least some of the plurality of light sources to illuminate particles brought to the particle inspection zone; capturing an image of the particle inspection zone; identifying objects in the image as being specular reflections based on locations of the objects in the image as corresponding to positions of the activated light sources; determining that the objects are water droplets; and rejecting the water droplets from an analysis of the image to identify the particles.

In an embodiment, a method includes: maintaining a library comprising a plurality of reference characteristics for a plurality of spores, the reference characteristics describing the spores under different levels of moisture saturation; acquiring an image of particles collected from ambient air; and selecting a reference characteristic to identify the particles from the image based on moisture levels in the ambient air.

In an embodiment, a method includes: collecting particles from ambient air; detecting condensation in the ambient air; activating countermeasures to compensate for the condensation; detecting a lack of condensation in the ambient air; and deactivating the countermeasures. Activating countermeasures may include increasing an airflow rate of the ambient air into a particle detector. Deactivating the countermeasures may include decreasing an airflow rate of the ambient air into a particle detector.

In an embodiment, a method includes: collecting particles from ambient air onto a tape media of a collection cartridge; advancing a portion of the tape media having the collected particles to a particle inspection zone; and before the portion of the tape media reaches the particle inspection zone, applying heat to the portion of the tape media.

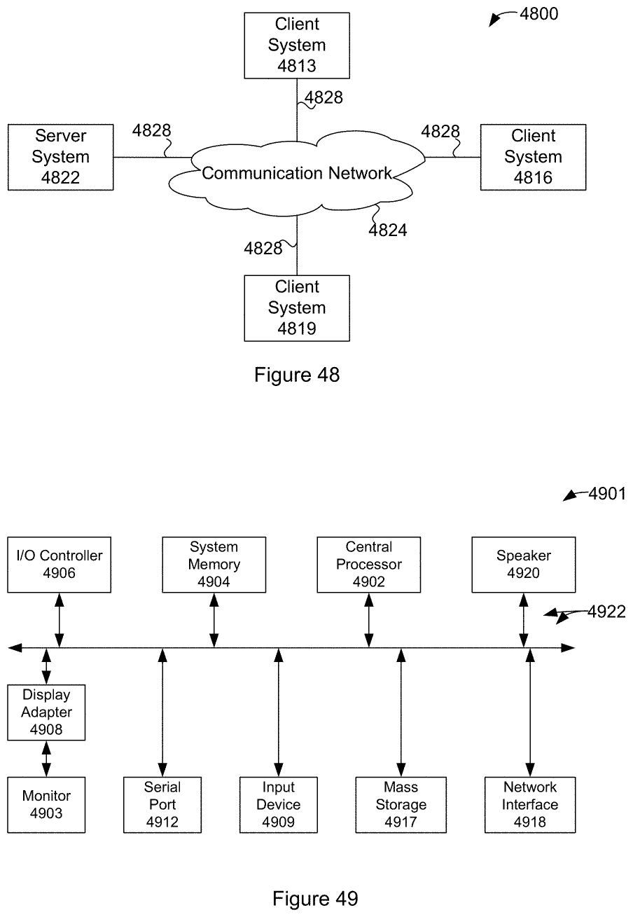

FIG. 48 is a simplified block diagram of a distributed computer network 4800 that may be used in one or more embodiments of a system for airborne particle collection, detection and recognition. Computer network 4800 includes a number of client systems 4813, 4816, and 4819, and a server system 4822 coupled to a communication network 4824 via a plurality of communication links 4828. There may be any number of clients and servers in a system. Communication network 4824 provides a mechanism for allowing the various components of distributed network 4800 to communicate and exchange information with each other.

Communication network 4824 may itself be comprised of many interconnected computer systems and communication links. Communication links 4828 may be hardwire links, optical links, satellite or other wireless communications links, wave propagation links, or any other mechanisms for communication of information. Various communication protocols may be used to facilitate communication between the various systems shown in FIG. 48. These communication protocols may include TCP/IP, HTTP protocols, wireless application protocol (WAP), vendor-specific protocols, customized protocols, and others. While in one embodiment, communication network 4824 is the Internet, in other embodiments, communication network 4824 may be any suitable communication network including a local area network (LAN), a wide area network (WAN), a wireless network, an intranet, a private network, a public network, a switched network, and combinations of these, and the like.

Distributed computer network 4800 in FIG. 48 is merely illustrative of an embodiment and is not intended to limit the scope of the embodiment as recited in the claims. One of ordinary skill in the art would recognize other variations, modifications, and alternatives. For example, more than one server system 4822 may be connected to communication network 4824. As another example, a number of client systems 4813, 4816, and 4819 may be coupled to communication network 4824 via an access provider (not shown) or via some other server system.

Client systems 4813, 4816, and 4819 enable users to access and query information stored by server system 4822. In a specific embodiment, a “Web browser” application executing on a client system enables users to select, access, retrieve, or query information stored by server system 4822. Examples of web browsers include the Internet Explorer® and Edge® browser programs provided by Microsoft® Corporation, Chrome® browser provided by Google®, and the Firefox® browser provided by Mozilla® Foundation, and others. In another specific embodiment, an iOS App or an Android® App on a client tablet enables users to select, access, retrieve, or query information stored by server system 4822. Access to the system can be through a mobile application program or app that is separate from a browser.

A computer-implemented or computer-executable version of the system may be embodied using, stored on, or associated with computer-readable medium or non-transitory computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present system may be stored or reside in RAM or cache memory, or on a mass storage device. The source, executable code, or both of the software may also be stored or reside on a mass storage device (e.g., hard disk, magnetic disk, tape, or CD-ROM). As a further example, code may be transmitted via wires, radio waves, or through a network such as the Internet.

A client computer can be a smartphone, smartwatch, tablet computer, laptop, wearable device or computer (e.g., Google Glass), body-borne computer, or desktop.

FIG. 49 shows a system block diagram of computer system 4901. Computer system 4901 includes monitor 4903, input device (e.g., keyboard, microphone, or camera) 4909, and mass storage devices 4917. Computer system 4901 further includes subsystems such as central processor 4902, system memory 4904, input/output (I/O) controller 4906, display adapter 4908, serial or universal serial bus (USB) port 4912, network interface 4918, and speaker 4920. In an embodiment, a computer system includes additional or fewer subsystems. For example, a computer system could include more than one processor 4902 (i.e., a multiprocessor system) or a system may include a cache memory.

Arrows such as 4922 represent the system bus architecture of computer system 4901. However, these arrows are illustrative of any interconnection scheme serving to link the subsystems. For example, speaker 4920 could be connected to the other subsystems through a port or have an internal direct connection to central processor 4902. The processor may include multiple processors or a multicore processor, which may permit parallel processing of information. Computer system 4901 shown in FIG. 49 is but an example of a suitable computer system. Other configurations of subsystems suitable for use will be readily apparent to one of ordinary skill in the art.

Computer software products may be written in any of various suitable programming languages, such as Python, C, C++, C#, Pascal, Fortran, Perl, Matlab® (from MathWorks), SAS, SPSS, JavaScript®, AJAX, Java®, SQL, and XQuery (a query language that is designed to process data from XML files or any data source that can be viewed as XML, HTML, or both). The computer software product may be an independent application with data input and data display modules. Alternatively, the computer software products may be classes that may be instantiated as distributed objects. The computer software products may also be component software such as Java Beans® (from Oracle Corporation) or Enterprise Java Beans® (EJB from Oracle Corporation). In a specific embodiment, a computer program product is provided that stores instructions such as computer code to program a computer to perform any of the processes or techniques described.

An operating system for the system may be Raspberry Pi OS by the Rasberry Pi Foundation, iOS by Apple®, Inc., Android by Google®, one of the Microsoft Windows® family of operating systems (e.g., Windows NT®, Windows 2000®, Windows XP®, Windows XP® x64 Edition, Windows 8, Windows 10), Linux, HP-UX, UNIX, Sun OS®, Solaris®, Mac OS X®, Alpha OS®, AIX, IRIX32, or IRIX64. Other operating systems may be used. Microsoft Windows® is a trademark of Microsoft® Corporation.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of the system using a wireless network using a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

In the description above and throughout, numerous specific details are set forth in order to provide a thorough understanding of an embodiment of this disclosure. It will be evident, however, to one of ordinary skill in the art, that an embodiment may be practiced without these specific details. In other instances, well-known structures and devices are shown in block diagram form to facilitate explanation. The description of the preferred embodiments is not intended to limit the scope of the claims appended hereto. Further, in the methods disclosed herein, various steps are disclosed illustrating some of the functions of an embodiment. These steps are merely examples, and are not meant to be limiting in any way. Other steps and functions may be contemplated without departing from this disclosure or the scope of an embodiment. Other embodiments include systems and non-volatile media products that execute, embody or store processes that implement the methods described above.

What is claimed is:

1. A particle detector comprising:
an opening into which ambient air outside the particle detector and comprising particles of interest to collect is drawn;
a light source;
a heater;
a sensor; and
a processor, coupled to the light source, heater, and sensor, wherein the heater increases a temperature at a particle inspection zone at which the particles are brought relative to a temperature of the ambient air, the light source illuminates the particles with light, the sensor detects and generates optical data resulting from the particles being illuminated with the light, and the processor analyzes the optical data received from the sensor to identify the particles.

2. The particle detector of claim 1 wherein the heater is positioned upstream of the particle inspection zone.

3. The particle detector of claim 1 wherein the heater comprises:
an axial resistor, coupled to the processor;
an insulating sleeve, containing the axial resistor, and having ends that are sealed; and
an opening formed in the sleeve and exposing a portion of the axial resistor.

4. The particle detector of claim 1 wherein the opening comprises:
an exterior side;
an interior side, opposite the exterior side; and
a concave surface on the interior side and surrounding at least a portion of the opening.

5. The particle detector of claim 1 comprising a desiccator.

6. The particle detector of claim 1 comprising an optical platform, the optical platform comprising:
a cartridge well for holding a removable cartridge, the removable cartridge having a first side, and a second side, adjacent to the first side, wherein when the removable cartridge is inserted into the particle detector, the first side faces the opening and the second side is at the particle inspection zone; and
a groove into which the heater is recessed.

7. The particle detector of claim 1 wherein the light source is a first light source of a plurality of light sources arranged about the particle inspection zone and coupled to the processor, the processor configured to perform a method comprising:
activating at least some of the plurality of light sources to illuminate particles brought to the particle inspection zone;
activating the sensor to capture an image of the particle inspection zone;
identifying objects in the image as being specular reflections based on locations of the objects in the image as corresponding to positions of the activated light sources;
determining that the objects are water droplets; and
rejecting the water droplets from an analysis of the image to identify the particles.

8. The particle detector of claim 1 wherein the processor is communicatively coupled to a storage device within which a library comprising a plurality of reference characteristics for a plurality of spores is maintained, the reference characteristics describing the spores under different levels of moisture saturation, and wherein the processor is configured to perform a method comprising:
acquiring, via the sensor, an image of particles collected from ambient air; and
selecting a reference characteristic to identify the particles from the image based on moisture levels in the ambient air.

9. The particle detector of claim 1 comprising an optical platform comprising:
a cartridge well for holding a collection cartridge within which the particles are collected, wherein the heater is coupled to the optical platform and positioned to be above the cartridge well.

10. The particle detector of claim 1 comprising a lens, wherein the heater does not contact the lens.

11. A method of operating a particle detector comprising:
collecting particles from ambient air onto a tape media of a collection cartridge;
advancing a portion of the tape media having the collected particles to a particle inspection zone; and
before the portion of the tape media reaches the particle inspection zone, applying heat to the portion of the tape media.

12. The method of claim 11 wherein the particle detector comprises an optical platform comprising:
a cartridge well for holding the collection cartridge; and
a heater for applying the heat, the heater being coupled to the optical platform and positioned to be above the cartridge well.

13. The method of claim 12 wherein the heater comprises:
an axial resistor;
an insulating sleeve, containing the axial resistor, to prevent heat transfer to the optical platform; and
an opening formed in the insulating sleeve and exposing a portion of the axial resistor to promote heat transfer to air in the cartridge well.

14. A particle detector comprising:
a camera sensor;
an optical platform comprising:
a cartridge well to hold a collection cartridge, the collection cartridge comprising a tape media, a collection zone at which particles are collected onto the tape media, a drying zone at which condensation on the tape media and saturating the particles is evaporated, and an inspection zone at which the particles are imaged by the camera sensor; and
a heater positioned to be above the drying zone of the collection cartridge, the heater comprising an axial resistor, an insulating sleeve containing the axial resistor, and an opening formed in the insulating sleeve to expose a portion of the axial resistor to the drying zone; and
an opening, facing the collection zone, and through which ambient air flows in a flow path from the collection zone to the drying zone to the inspection zone, wherein the heater is upstream of the particle inspection zone with respect to the flow path and generates heat to remove condensation from the tape media and collected particles before the collected particles are imaged by the camera sensor.

15. The particle detector of claim 14 wherein the insulating sleeve is positioned to be between the axial resistor and a material of the optical platform, the insulating sleeve thereby being arranged to reduce heat transfer to the optical platform while promoting heat transfer to the drying zone.
